(19) United States
(12) Patent Application Publication
(10) Pub. No.: US 2023/0136195 A1
(43) Pub. Date: May 4, 2023

(54) MODULAR POWER PACK ENERGY STORAGE UNIT

(71) Applicant: John Cronin, Jericho, VT (US)

(72) Inventor: John Cronin, Jericho, VT (US)

(21) Appl. No.: 17/976,674

(22) Filed: Oct. 28, 2022

Related U.S. Application Data
(60) Provisional application No. 63/273,129, filed on Oct. 28, 2021.

(51) Int. Cl. B60L 50/40; H02J 7/00

(52) U.S. Cl. CPC B60L 50/40; H02J 7/00712; H02J 7/0048; H02J 2207/50

(57) ABSTRACT

Disclosed herein is a modular energy storage unit comprising one or more power packs that comprise one or more supercapacitors. The one or more power packs may be coupled together in series or parallel and connected with charging hardware. The energy storage unit is associated with an energy control system that manages the charging and discharging of the power packs as the energy storage unit power a device such as an electric vehicle and when the energy storage unit is being charged. In related aspects, the energy storage unit receives charge from solar cells or other alternative energy sources, and charging of the power packs is managed according to a database of information about the individual power packs in the energy storage unit to individually delivery of charge to each power pack to optimize the overall performance of the energy storage unit.

### CROSS REFERENCE TO RELATED APPLICATIONS

The present application claims the priority benefit of U.S. provisional patent application 63/273,129 filed Oct. 28, 2021, the disclosure of which is incorporated herein by reference.

### FIELD OF THE DISCLOSURE

The present disclosure is generally related to an energy storage unit comprising supercapacitors and/or other energy sources. The energy storage unit can be used advantageously in electric vehicles, in energy storage from wind, solar power, or other alternative energy sources, and in many other settings.

### BACKGROUND

The subject matter discussed in the background section should not be assumed to be prior art merely due to its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Growth of electric vehicles has evolved exponentially in recent years. In addition, to electric passenger cars intended for use on standard vehicle byways, two general classes of vehicle propulsion systems have evolved to pure electric vehicles and hybrid electric vehicles. The shortcomings of batteries are well known, such as the difficulty determining the remaining charge in a battery, especially lithium batteries, but supercapacitors have not yet been able to effectively replace batteries both due to limited power density and the challenges of emulating the performance of batteries with steady discharge at a useful voltage. One problem in particular is the difficulty of charging a group of supercapacitors without causing damage by overcharging. Due to natural variance in supercapacitors and their performance and voltage after discharge, some may have much lower remaining charge than others, and applying charge uniformly to bring the group to a desired average voltage level may result in overcharging some supercapacitors and causing permanent damage. Simply charging to a lower level to avoid overcharging some results in lower efficiency. There is also a need for improved energy management relative to storing energy not only provided from, say, the grid to charge a device prior to use, but also to efficiently capture energy from systems such as regenerative energy (e.g., energy converted from vehicular kinetic energy during braking) or low-voltage or highly variable sources such as solar power, wind power, and other alternate energy sources, where existing energy storage is inefficient. There are also needs to improve not only charging from various sources, but also to control power delivery or discharging of the energy storage device in use for more efficient power use. Thus, there are a variety of needs for an improved energy storage unit and for the collective and individual control of energy sources in the energy storage unit during use as well as in charging.

Further, there is a need to prevent excessive temperature during use or charging, as well as a need to improve the safety features of supercapacitors and related energy storage units to reduce the risk of damage, temperature excursions, or electrical shock. There is also a need for better utilization of supercapacitor energy to meet the dynamic needs of electric vehicles and other devices. Similar needs exist for other energy sources such as batteries when used in electric vehicles or other devices and for hybrid systems with both batteries and supercapacitor systems.

There is thus a need for an improved energy storage unit, both for supercapacitor-based units and hybrid units, as well as battery-only systems in order to provide for efficient recharging and efficient charge utilization.

In a world of increasing security risks, the theft of valuable, portable electrical storage units is also a potential concern that has not been adequately addressed. There is a need for improved security systems for removable or portable ESUs in automobiles, e-bikes or motorcycles, and many other applications. In particular, there is a need for systems to prevent the use of unauthorized ESUs (i.e., stolen ESUs) and to reduce the risk of theft or misuse.

The energy storage units, devices, systems, and methods described and claimed herein may solve one or more of the problems mentioned above, but need not solve any or any one or more of these illustrative and non-comprehensive problems to be within the scope of the invention as claimed. The various problems mentioned above are not intended to be limiting regarding any aspect of the claimed invention.

### BRIEF DESCRIPTION OF THE DRAWINGS

The accompanying drawings illustrate various aspects of the systems, methods, and devices of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one. In some examples, an element shown as an internal component of one element may be implemented as an external component in another and vice versa. Furthermore, elements may not be drawn to scale. Non-limiting and non-exhaustive descriptions are described regarding the following drawings. The components in the figures are not necessarily to scale, emphasis instead being placed upon illustrating principles.

FIG. 1 a block diagram of one aspect a modular multi-type energy storage unit.

FIG. 2 illustrates one aspect of a charging database.

FIG. 3A and FIG. 3B illustrate a flowchart showing a method performed by one aspect of an energy control system.

FIG. 4 illustrates a flowchart showing a method performed by an electrostatic module.

FIG. 5 illustrates a flowchart showing a method performed by a supercapacitor module.

FIG. 6 illustrates a flowchart showing a method performed by a battery module.

FIG. 7 illustrates a flowchart showing a method performed by an identifier module.

FIG. 8 illustrates a flowchart showing a method performed by a charging module.

FIG. 9 illustrates a flowchart showing a method performed by a dynamic module.

FIG. 10 illustrates a flowchart showing a method performed by a communication module.

### DETAILED DESCRIPTION

Some aspects of this disclosure, illustrating all its features, will now be discussed in detail. The words “comprising,” “having,” “containing,” and “including,” and other forms thereof are intended to be equivalent in meaning and be open-ended in that an item or items following any one of these words is not meant to be an exhaustive listing of such item or items or meant to be limited to only the listed item or items.

It must also be noted that as used herein and in the appended claims, the singular forms “a,” “an,” and “the” include plural references unless the context clearly dictates otherwise.

Aspects of the present disclosure will be described with reference to the accompanying drawings in which like numerals represent like elements throughout the several figures and in which examples are shown. However, the claims should not be construed as limited to the examples herein, which are non-limiting examples and are merely examples among many possible examples.

Applicants have found that an energy storage unit (ESU) comprising supercapacitors and/or other energy sources can be provided with the energy density and other attributes needed for effective operation of an electric vehicle or other electric device, including improved charging and discharging to power the vehicle, particularly when coupled with a novel energy control system (ECS) adapted to control the ESU and optimize at least one of charging, discharging, temperature management, and anticipatory power delivery. The ECS may further communicate with a user interface such as a display interface to assist in control or monitoring of the ESU and also may comprise a processor and a memory. The ESU may further comprise hardware such as charging/discharging hardware and a temperature control system responsive to the ECS for regulating the ESU and its components.

Another aspect of the disclosure involves storing energy from solar power, wind power, or other alternative energy sources of many kinds (e.g., from waves, walking, etc.). The ESU with the ECS can be adapted to efficiently receive trickle charge or other low-voltage or highly variable current sources that are typical of alternative energy sources. The ECS in such cases may employ various tools to convert the incoming current to the desired voltage and/or current characteristics and then deliver it to charge the supercapacitors without overcharging. Such methods, in cooperation with the ECS, may include voltage booster circuits, flying capacitors, boost converter circuits, charge pumps, a voltage multiplier circuit with diodes and capacitors, and conversion of the DC current to AC current using an oscillating circuit followed by a step-up transformer to increase the voltage followed by conversion to DC current again. Alternatively or in addition, signal conditioning may be applied to match impedance of the alternative energy source and optimize power transfer to the ESU. However, solar cells may be provided with inverters already to provide AC current, in which case a rectifier could be used to create DC current, after which additional waveform manipulation may still be desirable, but when possible the inverter may simply be bypassed.

The ESU is a device that can store and deliver charge. It may comprise one or more power packs which in turn may comprise supercapacitors. The energy storage module may also comprise batteries, hybrid systems, fuel cells, etc. Capacitance provided in the components of the ESU may be in the form of electrostatic capacitance, pseudocapacitance, electrolytic capacitance, electronic double layer capacitance, and electrochemical capacitance, and a combination thereof, such as both electrostatic double-layer capacitance and electrochemical pseudocapacitance, as may occur in supercapacitors. The ESU may be associated with or comprise control hardware and software to provide an energy control system (ECS) to manage any of the following: temperature control, discharging of the ESU whether collectively or of any of its components, charging of the ESU whether collectively or of any of its individual components, maintenance, interaction with batteries or battery emulation, communication with other devices, including devices that are directly connected, adjacent, or remote such as by wireless communication. In some aspects, the ESU may be portable and provided in a casing that also contains the energy control system as well as other features such as communication systems, etc.

The energy control system (ECS) is the combination of hardware and software that manages various aspects of the ESU including the energy delivered by it to the device. The EUS may therefore manage any or all of the following: temperature control, discharging of the ESU whether collectively or of any of its components, charging of the ESU whether collectively or of any of its individual components, maintenance, interaction with batteries or battery emulation, and communication with other devices, including devices that are directly connected, adjacent, or remote such as by wireless communication.

The ECS may comprise one or more energy source modules that govern specific types of energy storage devices such as a supercapacitor module for governing supercapacitors, a lithium module for governing lithium batteries, a lead-acid module for governing lead-acid batteries, and a hybrid module for governing the combined cooperative use of a supercapacitor and a battery. Each of the energy storage modules may comprise software encoding algorithms for control such as for discharge or charging or managing individual energy sources, hardware for redistributing charge among the energy sources to improve efficiency of the ESU, charge measurement systems such as circuits for determining the charge state of the respective energy sources, means for receiving and sending information to and from the ECS or its other modules, etc. The energy source modules may also cooperate with a charging module responsible for guiding the charging of the overall ESU to ensure a properly balanced charge and a discharge module that guides the efficient discharging of the ESU during use which may also seek to provide proper balance in the discharging of the energy sources.

The ECS may further comprise a dynamic module for managing changing requirements in the power supplied. In some aspects, the dynamic module comprises anticipatory algorithms which seek to predict upcoming changes in power demand and to adjust the state of the ECS in order to be ready to more effectively handle the change. For example, in one case, the ECS may communicate with a GPS and/or terrain map for the route being taken by the electric vehicle and recognize that a steep hill will soon be encountered. The ECS may anticipate the need to increase torque and thus the delivered electrical power from the ESU, and thus activate additional power packs if only some are in use or otherwise increase the draw from the power packs in order to handle the change in slope efficiently to achieve desired objectives such as maintaining speed, reducing the need to shift gears on a hill, or reducing the risk of stalling or other problems.

The ECS may also comprise a communication module and an associated configuration system to properly configure the ECS to communicate not only with the interface or other aspects of the vehicle, but also to communicate with central systems or other vehicles, when desired. In such cases, a fleet of vehicles may be effectively monitored and managed to improve energy efficiency and track performance of vehicles and their ESUs, thereby providing information that may assist with maintenance protocols, for example. Such communication may occur wirelessly or through the cloud via a network interface, and may share information with various central databases, or access information from databases to assist with the operation of the vehicle and the optimization of the ESU, for which historical data may be available in a database.

Databases of use with the ECS include databases on the charge and discharge behavior of the energy sources in the ESU on order to optimize both charging and discharging in use based on known characteristics, databases of topographical and other information for a route to be taken by the electric vehicle or an operation to be performed by another device employing the ESU, wherein the database provides guidance on what power demands are to be expected in advance in order to support anticipatory power management wherein the status of energy sources and the available charge is prepared in time to deliver the needed power proactively. Charging databases may also be of use in describing the characteristics of an external power source that will be used to charge the ESU. Knowledge of the characteristics of the external charge can be used to prepare for impedance matching or other measures needed to handle a new input source to charge the ESU, and with that data the external power can be received with reduced losses and reduced risk of damaging elements in the ESU by overcharge, excessive ripple in the current, etc.

Beyond relying on static information in databases, in some aspects the controller is adapted to perform machine learning and to constantly learn from situations faced. In related aspects, the processor and the associated software form a “smart” controller based on machine learning or artificial intelligence adapted to handle a wide range of input and a wide range of operational demands.

The power pack is a unit that can store and deliver charge within an energy storage unit, and comprises one or more supercapacitors such as supercapacitors in series and/or parallel. It may further comprise or cooperate with temperature sensors, charge and current sensors (circuits or other devices), connectors, switches such as crosspoint switches, safety devices, and control systems such as charge and discharge control systems. In various aspects described herein, the power pack may comprise a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack may have a functional temperature range from −70° C. to +150° C., such as from −50° C. to 100° C. or from −40° C. to 80° C. The voltage provided by the power pack may be any practical value such as 3V or greater, such as from 3V to 240 V, 4V to 120 V, etc.

By way of example, a power pack may comprise one or more units each comprising at least one supercapacitor having a nominal voltage from 2 to 12 V such as from 3 to 6 V, including supercapacitors rated at about 3, 3.5, 4, 4.2, 4.5, and 5 V. For example, in discharge testing, a power pack was provided and tested with 14 capacitors in series and five series in parallel charged with 21,000 F at 4.2 V and had 68-75 Wh. Power packs may be packaged in protective casings that allow them to be easily removed from an ESU and replaced. They may also comprise connectors for charging and discharging. Power packs may be provided with generally rectilinear casings or they may have cylindrical or other useful shapes.

The supercapacitors of the power pack may be any of a wide variety of suitable supercapacitors. Principles for the design, manufacture, and operation of supercapacitors are described, by way of example, in US Patent Application US20190180949, “Supercapacitor,” published Aug. 29, 2017 by Liu Sizhi et al. and WO WO2018041095, “Supercapacitor,” published Mar. 8, 2018 by Liu Sizhi et al.; U.S. Pat. No. 9,318,271, “High temperature supercapacitor,” issued Apr. 19, 2016 to S. Fletcher et al.; US20150047844, “Downhole supercapacitor device”; US Patent Application 20200365336, “Energy storage device Supercapacitor and method for making the same”; U.S. Pat. No. 9,233,860, “Supercapacitor and method for making the same”; and U.S. Pat. No. 9,053,870, “Supercapacitor with a meso-porous nano graphene electrode.”

A supercapacitor may have two electrode layers separated by an electrode separator wherein each electrode layer is electrically connected to a current collector supported upon an inert substrate layer; further comprising an electrolyte-impervious layer disposed between each electrode layer and each conducting layer to protect the conducting layer; and a liquid electrolyte disposed within the area occupied by the working electrode layers and the electrode separator. The liquid electrolyte may be an ionic liquid electrolyte gelled by a silica gellant or other gellant to inhibit electrolyte flow.

The supercapacitor may comprise an electrode plate, an isolation film, a pole, and a shell, wherein the electrode plate comprises a current collector and a coating is disposed on the current collector. The coating may comprise an active material that may include carbon nanomaterial such as graphene or carbon nanotubes, including nitrogen-doped graphene, a carbon nitride, carbon materials doped with a sulfur compound such as thiophene or poly 3-hexylthiophene etc., or graphene on which is deposited nanoparticles of metal oxide such as manganese dioxide. The coating may further comprise a conductive polymer such as one or more of polyaniline, polythiophene and polypyrrole. Such polymers may be doped with a variety of substances such as boron (especially in the case of polyaniline). Nitrogen doping, for example, is described more fully by Tianquan Lin et al, “Nitrogen-doped mesoporous carbon of extraordinary capacitance for electrochemicalenergy storage,” Science (new series), vol. 350, no. 6267 (18 Dec. 2015): 1508-1513, https://www.jstor.org/stable/24741499.

Electrodes in supercapacitors may have thin coatings in electrical communication with a current collector. To provide high electrode surface area for high performance, electrodes may comprise porous material with high specific surface area such as graphene, graphene oxide, or various derivatives of graphene, carbon nanotubes or other carbon nanomaterials including activated carbon, nitrogen doped graphene or other doped graphene, graphite, carbon fiber-cloth, carbide-derived carbon, carbon aerogel, and/or may comprise various metal oxides such as oxides of manganese, etc., and all such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors pertaining to charge state, temperature, and other aspects of performance and safety. An actuation mechanism may be integrated to prevent undesired discharge.

The voltage of an individual supercapacitor may be greater than 2 V such as from 2.5 V to 5 V, 2.7 V to 8 V, 2.5 V to 4.5 V, etc.

The display interface may be displayed on or in the device, such as on a touch screen or other display in a vehicle or on the device, or it may be displayed by a separate device such as the user's phone. It may also be displayed on the ESU itself or on a surface connected to or in communication with the ESU. In one version, the display interface 146 may include but is not limited to a video monitoring display, a smartphone, a tablet, and the like, each capable of displaying a variety of parameters and interactive controls, but the display could also be as simple as one or more lights indicating charging or discharging status and optionally one or more digital or analog indicators showing remaining useful lifetime, % power remaining, voltage, etc. Further, the display interface may be any state-of-the-art display means without departing from the scope of the disclosure.

Electric vehicles may include automobiles, trucks, vans, fork lifts, carts such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like, etc. The electric vehicle generally comprises one or more motors connected to the ESU, and an energy control system (ECS) that controls the power delivered from the ESU, and may comprise a user interface that provides information and/or control regarding the delivery of power from the ESU as well as information regarding performance, remaining charge, safety, maintenance, security, etc.

Principles for the manufacture and design of electric vehicles and aspects of their charging are provided in US Patent Application 20190061541, “Electric vehicle batteries and stations for charging batteries”; EP2278677, “Safety Switch for Secondary Battery for Electric Vehicle and Charging/Discharging System for Secondary Battery for Electric Vehicle Using the Same”; US Patent Application 20190061541, “Electric vehicle batteries and stations for charging batteries”; etc.

Apart from electric vehicles, there are many other devices that may be powered by the ESU in cooperation with the ESC. Such other devices can include generators, which in turn can power an endless list of electric devices in households and industry. ESUs can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, etc. In some versions, the device being powered is the grid, and in such versions, the ESU may comprise a converter to turn DC current into AC current suitable for the grid.

In some aspects, a plurality of devices such as electric vehicles may be networked together via a cloud-based network, wherein the devices share information among themselves and/or with a central message center such that an administrator can assist in managing the allocation of resources, oversee maintenance, evaluate performance of vehicles and ESUs, upgrade software or firmware associated with the ESC to enhance performance for the particular needs of individual users or a collective group, adjust operational settings to better cope with anticipated changes in weather, traffic conditions, etc., or otherwise optimize performance.

### Implementation in Hybrid Vehicles

When installed in electric vehicles, the ESU may comprise both powerpacks as well as one or more lead-acid batteries or other batteries. The ESU may power both the motor as well as the on-board power supply system. The display interface of the associated ESC may comprise a graphic user interface such the vehicle's control panel (e.g., a touch panel). The display interface may also comprise audio information and verbal input from a user.

### Motors

Any kind of electric motor may be power by the ESU. The major classes of electric motors are: 1) DC motors, such as series, shunt, compound wound, separately excited (wherein the connection of stator and rotor is done using a different power supply for each), brushless, and PMDC (permanent magnet DC) motors, 2) AC motors such as synchronous, asynchronous, and induction motors (sometimes also called asynchronous motors), and 3) special purpose motors such as servo, stepper, linear induction, hysteresis, universal (a series-wound electric motor that can operate on AC and DC power), and reluctance motors.

### Display Interface

The display interface of the ESC may be displayed on or in the device, such as on a touch screen or other display in a vehicle or on the device, or it may be displayed by a separate device such as the user's phone. The display interface may comprise or be part of a graphic user interface such the vehicle's control panel (e.g., a touch panel). The display interface may also comprise audio information and verbal input from a user. It may also be displayed on the ESU itself or on a surface connected to or in communication with the ESU. In one version, the display interface may include but is not limited to a video monitoring display, a smartphone, a tablet, and the like, each capable of displaying a variety of parameters and interactive controls, but the display could also be as simple as one or more lights indicating charging or discharging status and optionally one or more digital or analog indicators showing remaining useful lifetime, % power remaining, voltage, etc. Further, the display interface may be any state-of-the-art display means without departing from the scope of the disclosure. In some aspects, the display interface provides graphical information on charge status including one or more of fraction of charge remaining or consumed, remaining useful life of the ESU or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU for shipping, discharge the ESU, increase active cooling, only apply low power, etc.); planned conditions for use (e.g., outdoors, high-humidity, in rain, underwater, indoors, etc.). Selections may be made through menus and/or buttons on a visual display, through audio “display” of information responsive to verbal commands, or through text commands or displays transmitted to a phone or computer, including text messages or visual display via an app or web page.

Thus, the ESU may comprise a display interface coupled to the processor to continuously display the status of charging and discharging the plurality of power packs.

### Solar Power and Alternate Energy Systems

Solar panels produce electrical power through the photovoltaic effect, converting sunlight into DC electricity. This DC electricity may be fed to a battery via a solar regulator to ensure proper charging and prevent damage to the battery. While DC devices can be powered directly from the battery or the regulator, AC devices require an inverter to convert the DC electricity to suitable AC current at, for example, 110V, 120V, 220V, 240V, etc.

Solar panels may be wired in series or in parallel to increase voltage or current, respectively. The rated terminal voltage of, say, a 12 Volt solar panel may actually be around 17 Volts, but the regulator may reduce the voltage to a lower level required for battery charging.

### Solar Regulators

Solar regulators (also called charge controllers) regulate current from the solar panels to prevent battery overcharging, reducing or stopping current as needed. They may also include a Low Voltage Disconnect feature to switch off the supply to the load when battery voltage falls below the cut-off voltage and may also prevent the battery sending charge back to the solar panel in the dark.

Regulators may operate with a pulse width modulation (PWM) controller, in which the current is drawn out of the panel at just above the battery voltage, or with a maximum power point tracking (MPPT) controller, in which the current is drawn out of the panel at the panel “maximum power voltage,” dropping the current voltage like a conventional step-down DC-DC converter, but adding the “smart” aspect of monitoring of the variable maximum power point of the panel to adjust the input voltage of the DC-DC converter to deliver optimum power.

### Inverters

Inverters are devices that converts the DC power to AC electricity. They come in several forms, including on-grid solar inverters that convert the DC power from solar panels into AC power which can be used directly by appliances or be fed into the grid. Off-grid systems and hybrid systems can also provide power to batteries for energy storage, but are more complex and costly that on-grid systems, requiring additional equipment. An inverter/charger that manages both grid connection and the charging or discharging of batteries may be called interactive or multi-mode inverters. A variation of such inverters is known as the all-in-one hybrid inverter.

Output from inverters may be in the form of a pure sine wave or a modified sine wave or squarewave. Some electronic equipment may be damaged by the less expensive modified sine wave output. In many conventional systems, multiple solar panels are connected to a single inverter in a “string inverter” setup. This can limit system efficiency, for when one solar panel is shaded and has reduced power, the overall current provided to the inverter is likewise reduced. String solar inverters are provided in single-phase and three-phase versions.

Microinverters are miniature forms of inverters that can be installed on the back of individual solar panels, providing the option for AC power to be created directly by the panel. For example, LG (Seoul, Korea) produces solar panels with integrated microinverters. Unfortunately, microinverters limit the efficiency of battery charging, for the AC power from the panels must be converted back to DC power for battery charging. They also add significant cost to the panels. The additional equipment on the panel may also increase maintenance problems and possibly the risk of lightning strikes. Microinverters generally use maximum power point tracking (MPPT) to optimize power harvesting from the panel or module it is connected to. An example of a microinverter is the Enphase M215 of Enphase Energy (Fremont, Calif.).

The on-grid string solar inverters and microinverters, collectively often simply called solar inverters, provide AC power that can be fed to the grid or directly to a home or office. Alternatively, off-grid inverters (or “battery inverters”) or hybrid inverters can charge batteries. Hybrid inverters can be used to charge batteries with DC current and to provide AC current for the grid or local devices, combining a solar inverter and battery inverter/charger into a single unit. An example of a hybrid inverter is the Conext SW 120/240 VAC hybrid inverter charger 48 VDC (865-4048) by Schneider Electric (Rueil-Malmaison, France) is a 4 kW (4000 watt) pure sine wave inverter or the 2.3 kW Outback Power Hybrid On/Off-grid Solar Inverter Charger 1-Ph 48 VDC by Outback Power (Phoenix, Ariz.).

Solar power systems may employ “deep cycle solar batteries,” which are designed for discharge over a long period of time (e.g., several days). Such batteries may be at risk of permanent damage is highly discharged, such as below 30% of capacity. They also may suffer the drawback of being able to deliver less total charge at a high load than at a low load due to problems of overheating at elevated discharge rates.

### Machine Learning and AI

The ECS or central systems in communication with the ECS may employ machine learning, including neural networks and AI systems, to learn performance profiles for individual powerpacks, supercapacitors, or entire ESUs, or those of a managed fleet of vehicles of collection of devices, in order to better estimate and optimize performance including such factors as remaining charge, remaining useful life, times for maintenance, methods for charge control to reduce overheating or to prevent other excursions or safety issues, and strategies to optimize lifetime or power delivery with a given ECS. Methods for adaptive learning, neural network analysis, or AI development that can be used with supercapacitor systems or the ESUs described herein include Jean-Noel Marie-Frangoise et al., “Supercapacitor modeling with Artificial Neural Network (ANN),” https://www.osti.gov/etdeweb/servlets/purl/20823689, accessed Nov. 1, 2021, which describes an Artificial Neural Network (ANN) using a black box nonlinear multiple inputs single output (MISO) model in which the system inputs are temperature and current, the output is the supercapacitor voltage. See also Elena Danila et al., “Dynamic Modelling of Supercapacitor Using Artificial Neural Network Technique,” International Conference and Exposition on Electrical and Power Engineering, October 2014, DOI: 10.1109/ICEPE.2014.6969988 and https://www.researchgate.net/publication/270888480_Dynamic_Modelling_of Supercapacitor_Using_Artificial_Neural_Network_Technique, which describes a feed forward artificial neural network structure with two hidden layers and with backpropagation training. Similar systems may be adapted for anticipatory power control as described herein. Also see Akram Eddahech, “Modeling and adaptive control for supercapacitor in automotive applications based on artificial neural networks,” Electric Power Systems Research, vol. 106 (January 2014): 134-141, https://www.sciencedirect.com/science/article/abs/pii/S0378779613002265, which seeks to predict power cycle behavior for supercapacitors using a one-layer feed-forward artificial neural network (ANN). Related publications include US Patent Application 20190097362, “Configurable Smart Object System with Standard Connectors for Adding Artificial Intelligence to Appliances, Vehicles, and Devices,” published Mar. 28, 2019 by B. Haba et al.; U.S. Pat. No. 9,379,546, “Vector control of grid-connected power electronic converter using artificial neural networks,” issued Jun. 28, 2016 to S. Li et al.; U.S. Pat. No. 7,548,894, “Artificial neural network,” issued Jun. 16, 2009 to Y. Fuji; and US Patent Application 20160283842, “Neural Network and Method of Neural Network Training United,” issued Sep. 29, 2016 to D. Pescianschi.

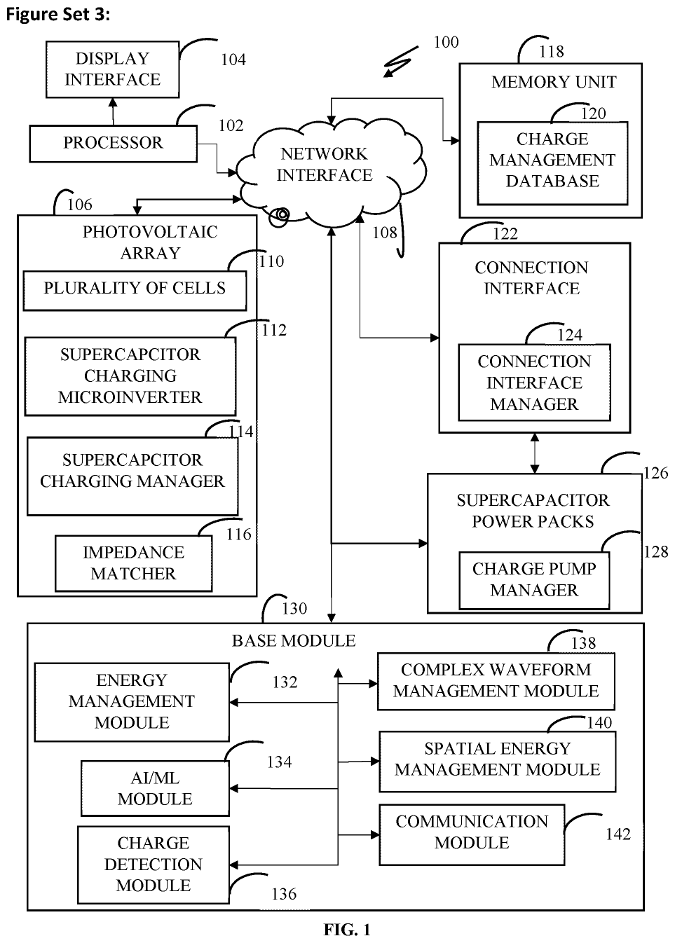

FIG. 1 illustrates a block diagram of a modular multi-type power pack energy storage unit (ESU) 100 and its associated energy control system (ECS) 101, which regulates aspects of the ESU 100 and its interaction with a device 162 which may be an electric vehicle (not shown) or other device. The ESU 100 may comprise one or more power packs 108, as well as batteries or other energy storage units 124, sensors 126 associated with the power packs 108 and optionally with the batteries or other energy storage units 124, and may further comprise charging and discharging hardware 160 and configuration hardware 104.

The charging and discharging hardware 160 comprises the wiring, switches, charge detection circuits, current detection circuits, and other devices for proper control of charge applied to the power packs 108 or to the batteries or other energy storage units 124, as well temperature-control devices such as active cooling equipment and other safety devices. Active cooling devices (not shown) may include fans, circulating heat transfer fluids that pass through tubing or in some cases surround or immerse the power packs 108, thermoelectric cooling such as Peltier effect coolers, etc.

In order to charge and discharge an individual unit among the power packs 108 to optimize the overall efficiency of the ESU, methods are needed to select one or more of many units from what may be a three-dimensional or two-dimensional array of connector to the individual units. Any suitable methods and devices may be used for such operations, including the use of crosspoint switches or other matrix switching tools. Crosspoint switches and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs 108 as well as the batteries or other energy storage units 124. SPST (Single-Pole Single-Throw) relays, for example, may be used. See “Understanding Tree and Crosspoint Matrix Architectures,” Pickering Test, https://www.pickeringtest.com/en-us/kb/hardware-topics/switching-architectures/understanding-tree-and-crosspoint-matrix-architectures, accessed Oct. 28, 2021. By applying charge to individual supercapacitors within powerpacks or to individual power packs within the ESU, charge can be applied directly to where it is needed and supercapacitor or power pack can be charged to an optimum level independently of other power packs or supercapacitors.

Examples of crosspoint switches and related components that may be adapted for one or more aspects of the disclosure herein, particularly the charging of supercapacitors or related power packs, are described in: “Digital Crosspoint Switches,” MicroSemi Corp. (Aliso Viejo, Calif.), https://www.microsemi.com/product-directory/signal-integrity/3579-digital-crosspoint-switches; “Micrel™ 2.5V/3.3V 3.0 GHz Dual 2×2 CML Crosspoint Switch w/Internal Termination, SuperLite™ SY55858U,” 2005, http://ww1.microchip.com/downloads/en/DeviceDoc/sy55858u.pdf, “Details, datasheet, quote on part number: BQ24640RVAR,” part of the BQ24640 family for “High Efficiency Synchronous Switch-Mode Battery Charge Controller for Super Capacitors,” Texas Instruments (Dallas, Tex.), https://www.digchip.com/datasheets/3258066-bg24640rvar.html; “8×8 Analog Crosspoint Switches Analog & Digital Crosspoint ICs,” Mouser Electronics (Mansfield, Tex.), https://www.mouser.com/c/semiconductors/communication-networking-ics/analog-digital-crosspoint-ics/; “200-MHz 16×16 Video Crosspoint Switch IC,” Analogue Dialogue, April 1997, https://www.analog.com/en/analog-dialogue/articles/200-mhz-16×16-video-crosspoint-switch-ic.html; “Crossbar Switch,” and Wikipedia, https://en.wikipedia.org/wiki/Crossbar_switch, accessed Oct. 28, 2021.

The configuration hardware 104 comprises the switches, wiring, and other devices to transform the electrical configuration of the power packs 108 between series and parallel configurations, such as that a matrix of power packs 108 may be configured to be in series, in parallel, or in some combination thereof. For example, as 12×6 array of power packs 108 may 4 groups in series, with each group having 3×6 power packs in parallel. The configuration can be modified by a command from the configuration module 136 which then causes the configuration hardware 104 to make the change at an appropriate time (e.g., when the device 162 is not in use).

The sensors 126 may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs 108 or batteries or other energy storage units 124, or other characteristics of the ESU 100 or the device 162, as described more fully hereafter. The sensors 126 may comprise sensors physically contained in or on the ESU 100, or also comprise sensors mounted elsewhere such as engine gauges that are in electronic communication with the ECS 100 or its associated ESC 101.

The ESU 100 also comprises or is associated with a power input/output interface 152 that can receive charge from a device 162 (or a plurality of devices in some cases) such as the grid or from regenerative power sources in an electric vehicle (not shown), and can deliver charge to a device 162 such as an electric vehicle (not shown). The power input/output interface 152 may comprise one or more inverters, charge converters, or other circuits and devices to convert the current to the proper type (e.g., AC or DC) and voltage or amperage for either supplying power to or receiving power from the device it is connected to (not shown).

The ESU 100 may be capable of charging, or supplementing the power provided from the batteries or other energy storage units 124 including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox-flow batteries, supercapacitor batteries, and combinations or hybrids thereof.

The ESU 100 comprises or is operatively associated with an energy control system (ECS) 101 that may comprise a processor 102, a memory 103, one or more energy source modules 122, a charge/discharge module 132, a communication module 128, a configuration module 136, a dynamic module 134, an identifier module 138, a security module 140, a safety module 142, a maintenance module 156, a performance module 150, and a user interface 146.

The sensors 126 may communicate with the safety module 142 to determine if the temperature of the power packs 108 and/or individual components therein show signs of excessive local or system temperature that might lead to harm to the components. In such cases, the safety module 142 interacts with the processor 102 and other features (e.g., data stored in the databases 144 of the cloud 114 or in memory 103 pertaining to safe temperature characteristics for the ESU 100) to cause a change in operation such as decreasing the charging or discharging underway with the portions of the power packs 108 or other units facing excessive temperature. The safety module 142 may also regulate cooling systems that are part of the charging and discharging hardware 160 in order to proactively increase cooling of the power packs 108 or batteries or other energy storage units 124, such that increasing the load on them does not lead to harmful temperature increase.

Thus, the safety module 142 may also interact with the dynamic module 134 in responding to forecasts of system demands in the near future for anticipatory control of the ESU 100 for optimized power delivery. In the interaction with the dynamic module 134, the safety module may determine that an upcoming episode of high system demand such as imminent climbing of a hill may imposes excessive demands on a power pack already operating at elevated temperature, and thus make a proactive recommendation to increase cooling on the at-risk power packs 108. Other sensors such as strain gauges, pressure gauges, chemical sensors, etc., may be provided to determine if any of the energy storage units in batteries or other energy storage units 124 or the power packs 108 are facing pressure buildup from outgassing, decomposition, corrosion, electrical shorts, unwanted chemical reactions such as an incipient runaway reaction, or other system difficulties. In such cases, the safety module 142 may then initiate precautionary or emergency procedures such as a shut down, electrical isolation of the affected components, warnings to a system administrator via the communication module 128 to the message center 154, a request for maintenance to the maintenance module 156.

The processor 102 may comprise one or more microchips and can provide instructions to regulate the charging and discharging hardware and configuration hardware 104.

The memory 103 may comprise coding for operation of one or more of the ECS modules 122, 128, 132, 134, 136, 138, 140, 142, 150 and their interactions with each other or other components. It may also comprise information such as databases pertaining to any aspect of the operation of the ECS, though additional databases 144 are also available via the cloud 114. Such databases can include a charging database that describes the charging and/or discharging characteristics of a plurality or all of the energy sources (the power packs 108 and the batteries or other energy storage units 124), for guiding charging and discharging operations. Such data may also be included with energy-source-specific data provided by or accessed by the energy source modules 122.

The ECS 101 may communicate with other entities via the cloud 114 or other means, and such communication may involve information received from and/or provided to one or more databases 144 and a message center 154. The message center 154 can be used to provide alerts to an administrator responsible for the ESU 100 and/or the electric vehicle or other device. For example, an entity may own a fleet of electric vehicles using ESUs 100, and may wish to receive notifications regarding usage, performance, maintenance issues, and so forth. The message center 146 may also participate in authenticating the ESU 100 or verifying its authorization for use in the electric vehicle or other device (not shown) via interaction with the security module 140.

The energy source modules 122 may comprise specific modules designed for the operation of a specific type of energy source such as supercapacitor module, a lithium battery module, a lead-acid battery module, or other modules. Such modules may be associated with a database of performance characteristics (e.g., charge and discharge curves, safety restrictions regarding overcharge, temperature, etc.) that may provide information for use by the safety module 142 and the charge/discharge module 132, which is used to optimize the way in which each unit within the power packs 108 or batteries or other energy storage units 124 is used both in terms of charging and delivering charge. The charge/discharge module 132 seeks to provide useful work from as much of the charge as possible in the individual power packs 108 while ensuring that individual power packs 108 are fully charged but not damaged by overcharging. The charge/discharge module 132 can assist in directing the charging/discharging hardware 160, cooperating with the energy source modules 122. In one aspect, the ESU 100 thus may provide real-time charging and discharging of the plurality of power packs 108 while the electric vehicle is continuously accelerating and decelerating along a path.

The dynamic module 134 assists in coping with changes in operation including acceleration, deceleration, stops, changes in slops (uphill or downhill), changes in traction or properties of the road or ground that affect traction and performance, etc., by optimizing the delivery of power or the charging that is taking place for individual power packs 108 or batteries or other energy storage units 124. In addition to guiding the degree of power provided by or to individual power packs 108 based on current use of the device 162 and the individual state of the power packs 108, in some aspects the dynamic module 134 provides anticipatory management of the ESU 100 by proactively adjusting the charging or discharging states of the power packs 108 such that added power is available as the need arises or slightly in advance (depending on time constants for the ESU 100 and its components, anticipatory changes in status may only be needed for a few seconds (e.g., 5 seconds or less or 2 seconds or less) or perhaps only for 1 second or less such as for 0.5 seconds or less, but longer times of preparatory changes may be needed in other cases, such as from 3 seconds to 10 seconds, to ensure that adequate power is available when needed but that power is not wasted by changing the power delivery state prematurely. This anticipatory control can involve not only increase the current or voltage being delivered, but can also involve increasing the cooling provided by the cooling hardware of the charging and discharging hardware 160 in cooperation with safety module 142 and when suitable with the charge/discharge module 132.

The identifier module 138, described in more detail hereafter, identifies the charging or discharging requirement for each power pack 108 to assist in best meeting the power supply needs of the device 162. This process may require access to database information about the individual power packs 108 from the energy source modules 122 (e.g., a supercapacitor module) and information about the current state of the individual power packs 108 provided by the sensors 126 and charge and current detections circuits associated with the charging and discharging hardware 160, cooperating with the charge/discharge module 132 and, as needed, with the dynamic module 134 and the safety module 142.

The ESU 100 may comprise a display interface 146 coupled to the processor 102 to continuously display the status of charging and discharging the plurality of power packs 108. It can be noted that the display interface 146 may be a display screen or a speaker, and the display device may be attached to the ESU, the device 162, or to another object such as the user's cell phone screen. In one aspect, the display interface 146 may be integrated within the electric vehicle to display charging and discharging of the plurality of power packs 108.

The maintenance module 156 determines when the ESU requires maintenance, either per a predetermined scheduled or when needed due to apparent problems in performance, as may be flagged by the performance module 150, or in issues pertaining to safety as determined by the safety module 142 based on data from sensors 126 or the charging/discharging hardware, and in light of information from the energy sources modules 122. The maintenance module 156 may cooperate with the communication module 128 to provide relevant information to the display interface 146 and/or to the message center 154, where an administrator or owner may initiate maintenance action in response to the message provided. The maintenance module 156 may also initiate mitigating actions to be taken such as cooperating with the charge/discharge module 132 to decrease the demand on one or more of the power packs 108 in need of maintenance, and may also cooperate with the configuration module 136 to reconfigure the power packs 108 to reduce the demand in components that may be malfunctioning of near to malfunctioning to reduce harm and risk.

The performance module continually monitors the results obtained with individual power packs 108 and the batteries or other energy storage units 124 and stores information as needed in memory 103 and/or in the databases 144 of the cloud 114 or via messages to the message center 154. The monitoring is done through the use of the sensors 126 and the charging/discharging hardware 160, etc. The tracking of performance attributes of the individual energy sources can guide knowledge about the health of the system, the capabilities of the components, etc., which can guide decisions about charging and discharging in cooperation with the charge/discharge module 132. The performance module 150 compares actual performance, such as power density, charge density, time to charge, thermal behavior, etc., to specifications and can then cooperate with the maintenance module 156 to help determine if maintenance or replacement is needed, and alert an administrator via the communication module 128 with a message to the message center 154 about apparent problems in product quality.

### The Security Module: Security Issues and Anti-Counterfeiting Measures

The security module 140 helps to reduce the risk of counterfeit products or of theft or misuse of legitimate products associated with the ESU 100, and thus can include one or more methods for authenticating the nature of the ESU 100 and/or authorization to use it with the device 162 in question. Methods of reducing the risk of theft of unauthorized use of an ESU 100 or its respective power packs 108 can include locks integrated with the casing of the ESU 100 that mechanically secure the ESU 100 in the electric vehicle or other device, wherein a key, a unique fob, a biometric signal such as a finger print or voice recognition system, or other security-related credentials or may be required to enable removal of the ESU 100 or even operation thereof.

In another aspect, the ESU 100 comprises a unique identifier (not shown) that can be tracked, allowing a security system to verify that a given ESU 100 is authorized for use with the device 162, such as an electric vehicle or other device. For example, the casing of the ESU 100 or of one or more power packs 108 therein may have a unique identifier attached such as an RFID tag with a serial number (an active or passive tag), a holographic tag with unique characteristics equivalent to a serial number or password, nanoparticle markings that convey a unique signal, etc. One exemplary security tool that may be adapted for the security of the ESU is a seemingly ordinary bar code or QR code with unique characteristics not visible to the human eye that cannot be readily copied, is the Unisecure™ technology offered by Systech (Princeton, N.J.), a subsidiary of Markem-Image, that essentially allows ordinary QR codes and barcodes to become unique, individual codes by analysis of tiny imperfections in the printing to uniquely and robustly identify every individual products, even if it seems that the same code is printed on every one. The technology is described in part in U.S. patent Ser. No. 10/380,601, “Method and system for determining whether a mark is genuine,” issued Aug. 13, 2019 to M. L. Soborski; U.S. Pat. No. 9,940,572, “Methods and a computing device for determining whether a mark is genuine,” issued Apr. 10, 2018 to M. L. Soborski; U.S. patent Ser. No. 10/235,597, “Methods and a computing device for determining whether a mark is genuine,” issued Mar. 19, 2019 to M. Voigt et al.; U.S. Pat. No. 9,519,942, “Methods and a computing device for determining whether a mark is genuine,” issued Dec. 13, 2016 to M. L. Soborski; and U.S. Pat. No. 8,950,662, “Unique identification information from marked features,” issued Feb. 10, 2015 to M. L. Soborski.

Yet another approach relies at least in part in the unique electronic signature of the ESU, and/or of one or more individual power packs or of one or more supercapacitor units therein. The principle will be described relative to an individual power pack, but may be adapted to an individual supercapacitor or collectively to the ESU 100 as a whole. When a power pack 108 comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack 108 may then be tested using any suitable tool capable of identifying a signature specific to the individual power pack. Such techniques may include impedance spectroscopy, cyclic voltammetry, etc., measured under conditions such as Cyclic Charge Discharge (CCD), galvanostatic charge/discharge, potentiostatic charge/discharge, and impedance measurements. etc. An electronic signature of time effects (characteristic changes in time of voltage or current, for example, is response to an applied load of some kind) may be explored for a specified scenario such as charging a 90% discharged power pack to a state of 50% charge, or examining the response to difference applied voltages such as −3V to +4V. Voltammograms may be obtained showing, for example, the response of the power pack to different scan rates. See, for example, “Testing Super-Capacitors, Part 1: CV, EIS, and Leakage Current,” Apr. 16, 2015, https://www.gamry.com/assets/Uploads/Super-capacitors-part-1-rev-2.pdf, and “Testing Electrochemical Capacitors Part 2—Cyclic Charge Discharge and Stacks,” Nov. 14, 2011, https://www.gamry.com/assets/Application-Notes/Testing-Super-Capacitors-Pt2.pdf. Instrumentation for such testing may include a variety of electrical signal analysis tools, including, for example, the Gamry Instruments PWR800 system (Gamry Instruments Inc., Warminster, Pa.). Also see Erik Surewaard et al., “A Comparison of Different Methods for Battery and Supercapacitor Modeling,” SAE Transactions, Journal of Engines, vol. 112, Section 3 (2003): 1851-1859, https://www.jstor.org/stable/44741399. Also see Yuru Ge et al., “How to measure and report the capacity of electrochemical double layers, supercapacitors, and their electrode materials,” Journal of Solid State Electrochemistry, vol. 24 (2020): 3215-3230, https://link.springer.com/article/10.1007/s10008-020-04804-x.

Recognizing that the details of supercapacitor response to a certain load or charge/discharge process may vary gradually over time, especially if the supercapacitor has been exposed to excess voltage or other mechanical or electrical stress, the security module can be adaptive and recognize and accept change within certain limits. Changes observed in the response characteristics can be used to update a security database or performance database for the ESU, so that future authentication operations will compare the measured behavior profile of the ESU's power pack in question with the updated profile for authentication purposes and for tracking of performance changes over time. Such information may also be shared with the maintenance module including the maintenance database, which may trigger a request or requirement for service if there are indications of damage pointing to the need of repair or replacement. When a power pack or supercapacitor therein is replaced due to damage, the response profile of the power pack can then be updated in the security database. When such physical changes cause changes to the measured electronic characteristics that exceed a reasonable threshold, the authorization for use of that ESU may be withdrawn pending further confirmation of authenticity or necessary maintenance.

In another aspect, each ESU and optionally each power pack of the ESU may be associated with a unique identifier registered in a blockchain system, and each “transaction” of the ESU such as each removal from a vehicle, maintenance operations, purchase or change in ownership, and installation into a vehicle or other device can be recorded and tracked. A code, RFID signal, or other identifier may be read or scanned for each transaction, such that the blockchain record may then be updated. The blockchain record may comprise an information about the authorization state of the product, such as information on what vehicle or vehicles or products the ESU is authorized for, or an identifier associated with the authorized user may be provided which can be verified or authenticated when the ESU is installed in a new setting or when a transaction occurs. The authorization record may be updated at any time, including when a transaction occurs. Mechanisms may be provided by the vendor to resolve disputes regarding authorization status or other questions.

In some aspects, such as in military or government operation, the ESU 100 may comprise an internal “kill switch” or other inactivation device that can be remotely activated by authorities in the event of a crime, unauthorized use, or violation of contract. Alternatively or in addition, an electric vehicle or other device may be adapted to reject installation of an ESU 100 that is not authorized for use in the vehicle or device 162.

### Further Information

The ECS 101 may access various databases 144 via an interface to the cloud 114 and store retrieved information in the memory 103 for use to guide the various modules. The memory 103 be configured to receive a set of instructions from the processor 102 while charging and discharging the power packs 108. In one aspect, the set of instructions may activate a charging mode or a discharging mode to charge or discharge the power packs 108. Communication to the cloud 114 may occur via the communication module 128 and may involve a wired or a wireless connections. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

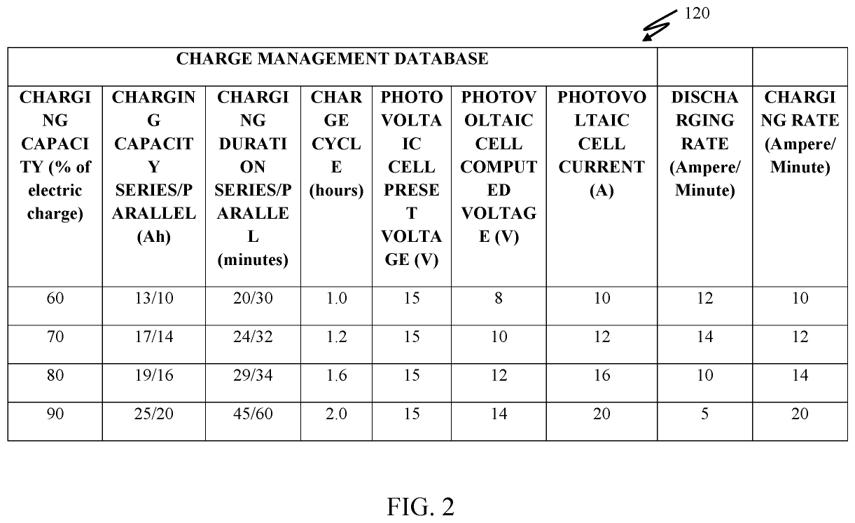

Further, the memory 103 may comprise a charging database 116 or information from such a database obtained from the databases 144 of the cloud 114. The charging database 116 is described in FIG. 2. In one aspect, the charging database 116 may be configured to store information related to various power packs 108 used while charging and discharging from the ESU 100. In one aspect, the charging database 116 may be configured to store information related to the power cycle of each of the plurality of power packs 108, the maximum and minimum charge for different types of power packs, and the state of charge (SoC) profile of each of the plurality of power packs 108.

Further, the charging database 116 may be configured to store information related to the management of the plurality of power packs 108. In one aspect, the information may include, but is not limited to, the type of power pack to be charged, safety specifications, recent performance data, bidirectional charging requirements or history of each of the plurality of power packs 108, etc. In another aspect, the stored information may also include, but is not limited to, the capacity of each of the plurality of power packs 108, amount of charge required for one trip of the electric vehicle along the path, such as golf course, etc., charging required for a supercapacitor unit, and acceleration and deceleration data related to the path of the electric vehicle. In another aspect, the charging database 116 may provide a detailed research report for the electric vehicle's average electric charge consumption over a path. In one aspect, the charging database 116 may be configured to store information of the consumption of the electric charge per unit per kilometer drive of the electric vehicle from the plurality of power packs 108. For example, a golf cart is installed with 15 lithium batteries coupled in series; each lithium battery will supply 13 Ampere Hour (Ah) of the electric charge for one hour to drive the golf cart for a distance of one kilometer with an average velocity of 6 m/s, etc.

Further, the modular multi-type power pack energy storage unit 100 may comprise a plurality of modules, as discussed below, to evaluate and enhance the performance of charging and discharging the capacity of the plurality of power packs 108. In one aspect, the plurality of modules may enhance the performance of the electric vehicle by supplying the electric charge from the plurality of power packs 108 according to the need of the electric vehicle.

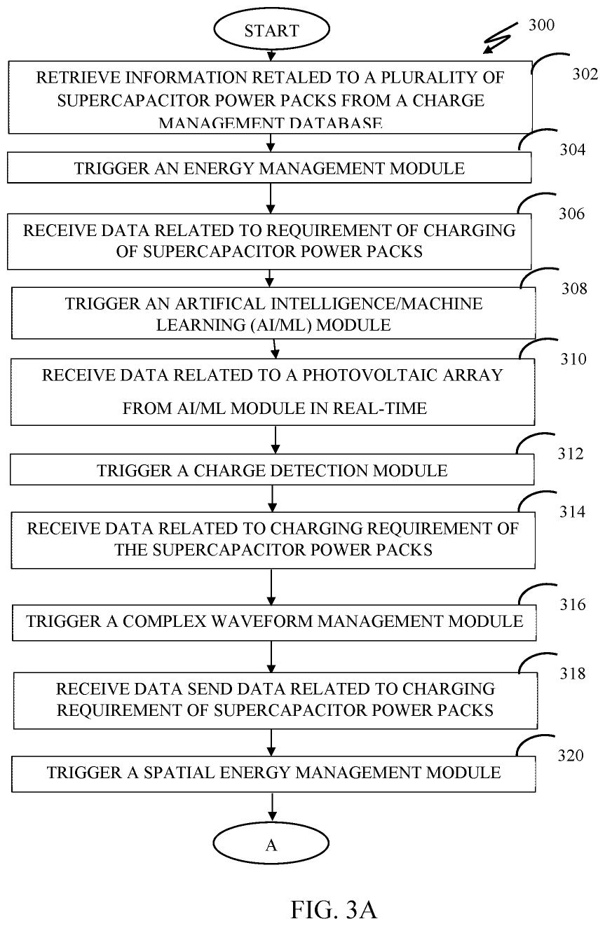

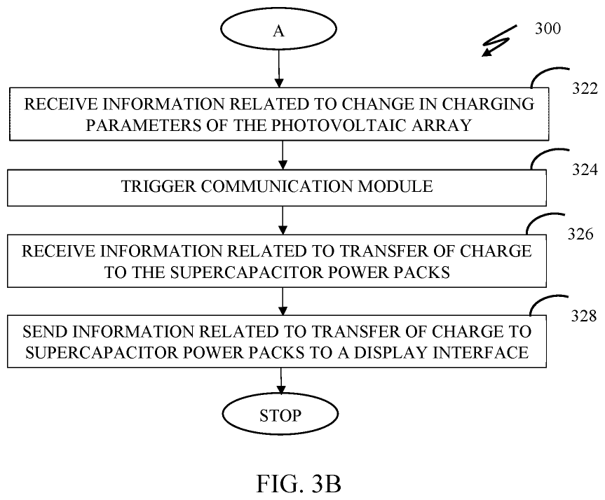

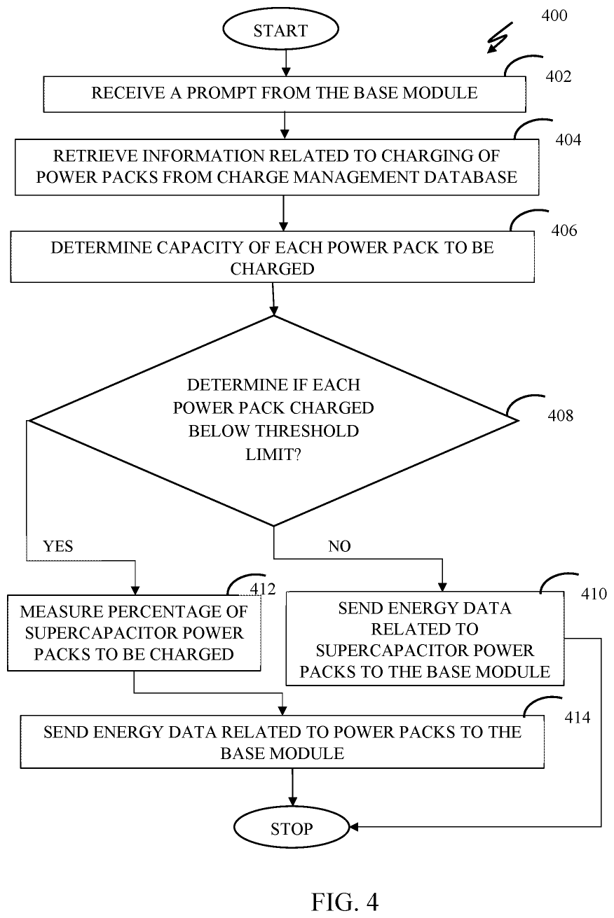

One aspect of the ECS 101 is described in FIGS. 3A-3B. In one aspect, the ECS 101 may act as a central module to receive and send instructions to each of the plurality of modules. In another aspect, the ECS 101 may be configured to activate or deactivate a plurality of sub-modules according to the information received from the processor 102 and the memory unit 112. The ECS 101 may be in communication with the network interface 114. Further, the ECS 101 may comprise an electrostatic module to determine data related to a type of power packs. In one aspect, the electrostatic module may be configured to determine the percentage of electric charge available in each of the plurality of power packs 108. The electrostatic module is described in FIG. 4.

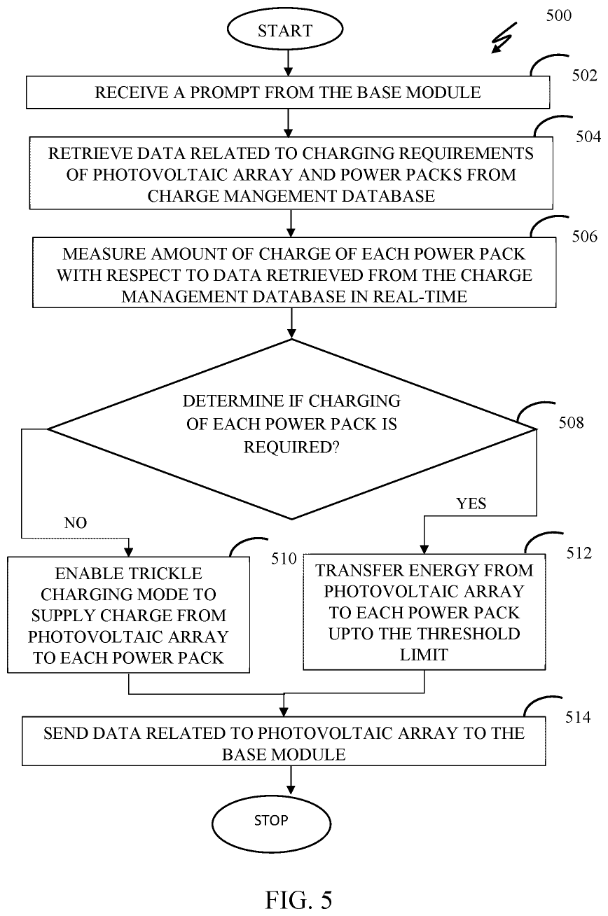

Further, the ECS 101 may comprise a supercapacitor module within the energy source modules 122 to evaluate and charge the plurality of power packs 108 according to the percentage of electric charge available in each of the plurality of power packs 108 determined by the charging/discharging hardware 160 in cooperation with the performance module 150 and/or the chare/discharge module 132. In one aspect, the ECS 101 may be configured to receive an input request from the charge/discharge module 132 related to the requirement of the electric charge of the plurality of power packs 108. In one aspect, the supercapacitor module within the energy source modules 122 may be activated and deactivated automatically by the ECS 101 according to the input request. In one aspect, the supercapacitor module within the energy source modules 122 may be configured to retrieve data related to each of the plurality of power packs 108 from the charging database 116. In one aspect, the data related to each of the plurality of the power packs 108 may be an amount of electric charge stored in each of the plurality of power packs 108. In another aspect, the supercapacitor module 122 may be configured to measure the amount of the electric charge of each of the plurality of power packs 108 with respect to the data retrieved from the charging database 116. Further, the supercapacitor module within the energy source modules 122 may cooperate with the identifier module 138 to determine whether charging of individual supercapacitors or of the entire plurality of power packs 108 is needed or not. The supercapacitor module within the energy source modules 122 is described in FIG. 5.

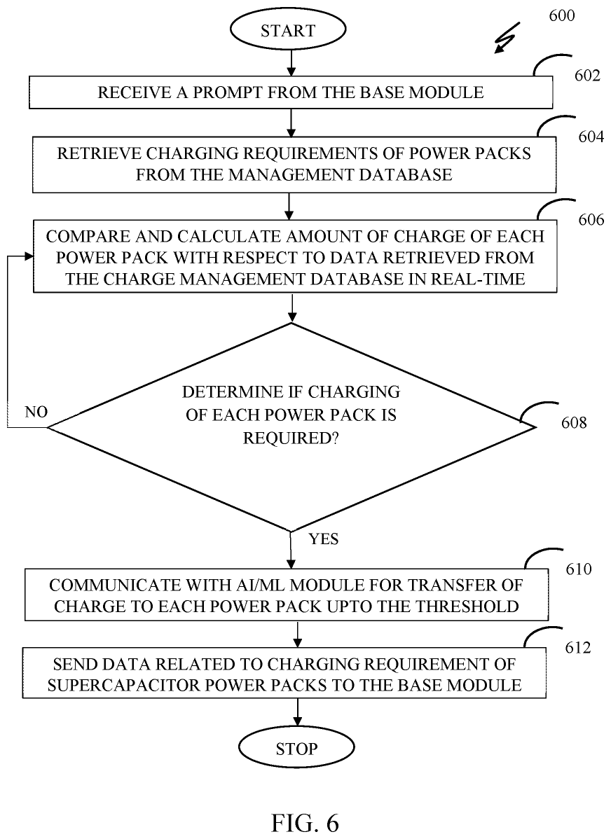

Further, the ECS 101 may comprise a battery module within the energy source modules 122 such as a lithium module to evaluate and charge the batteries or other energy storage units 124 according to the percentage of electric charge available therein as determined by the charging and discharging hardware 160 in cooperation with the performance module 150 and/or charge/discharge module 132. In one aspect, the lithium module may function similarly to the supercapacitor module. Further, the lithium module may be configured to charge or discharge lithium batteries, when present. The lithium module is described in FIG. 6, which also applies to the lead-acid battery module or other battery modules within the energy source modules 122.

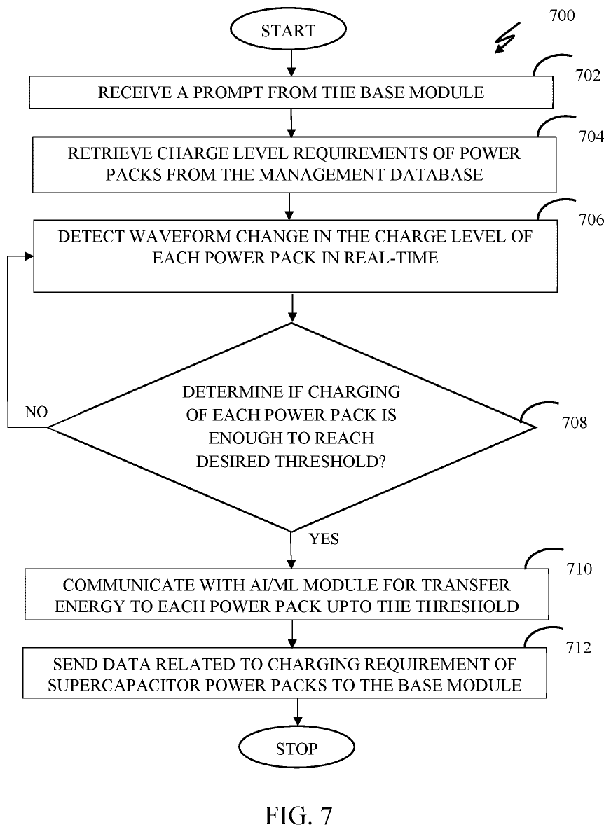

Further, the ECS 101 may comprise an identifier module 138 configured to identify charging requirements of the plurality of power packs 108. For example, in one aspect, the identifier module 138 may retrieve information from the charging database 116 to evaluate the charge requirement of each of the plurality of power packs 108 for charging or discharging when connected to the ESU 100. The identifier module 138 is described in FIG. 7.

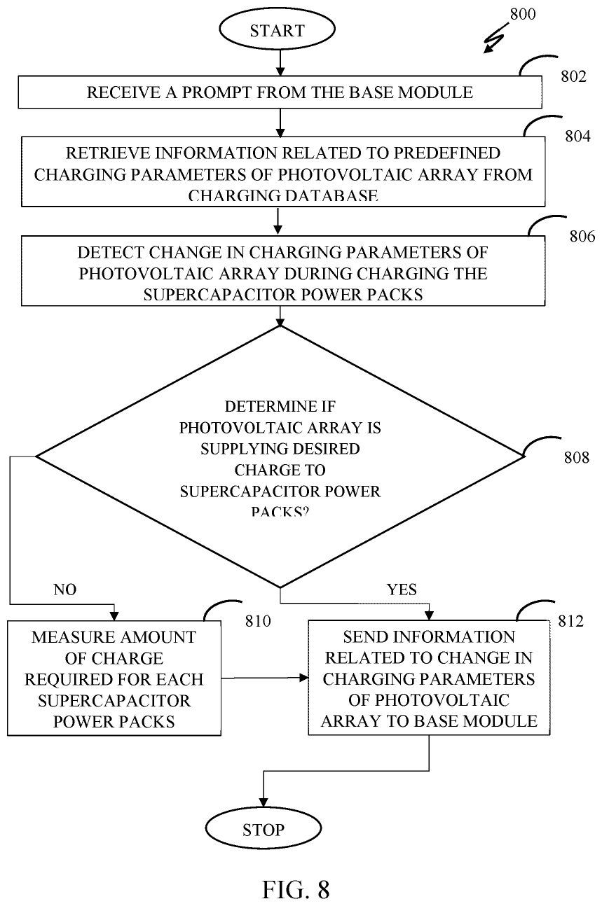

Further, the charge/discharge module 132 may be communicatively coupled to the performance module 150, the energy storage modules 122, and the identifier module 138. Further, the charging module 132 may be configured to charge or discharge each of the plurality of power packs 108 up to a threshold limit. For example, in one aspect, the threshold limit may be more than 90 percent capacity of each of the plurality of power packs 108. The charging module 132 is described in FIG. 8.

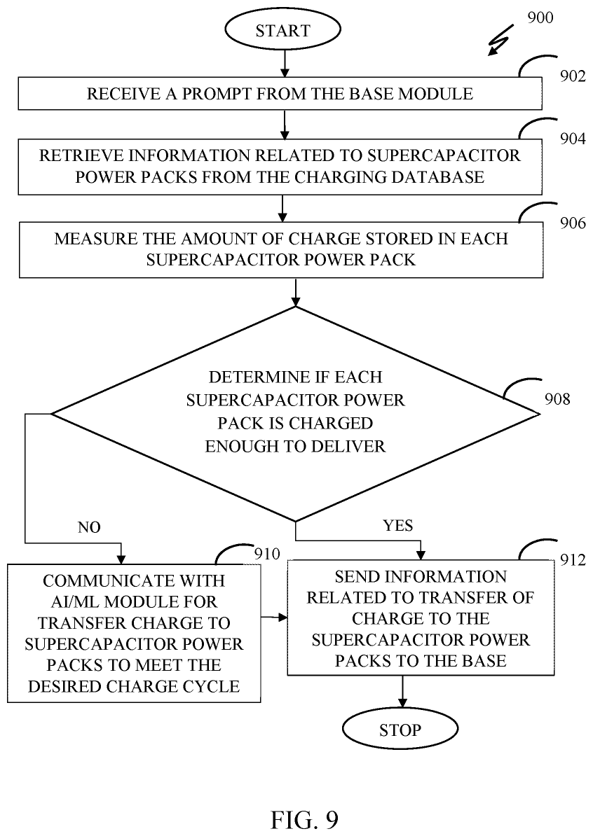

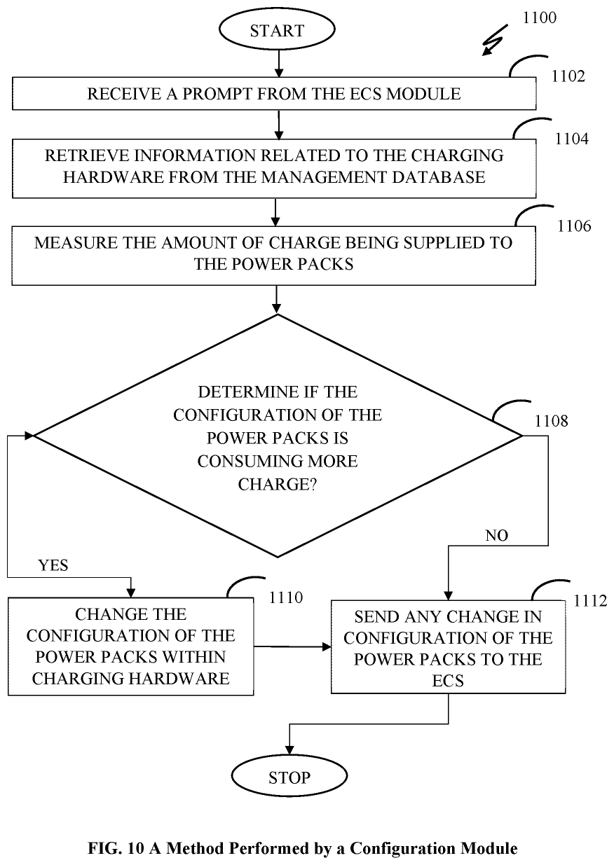

Further, the ECS 101 may comprise a dynamic module 134, communicatively coupled to the charge/discharge module 132. The dynamic module 134 may be configured to determine the charging and discharging status of the plurality of power packs 108 and batteries or other energy storage units 124 in real-time. For example, in one aspect, the dynamic module 134 may help govern bidirectional charge/discharge in real-time in which the electric charge may flow from the ESU 100 into the plurality of power packs 108 and/or batteries or other energy storage units 124 or vice versa. The dynamic module 134 is described in FIG. 9. Further, the ECS 101 may comprise a configuration module 136 configured to determine any change in configuration of charged power packs from the charging module 132. For example, in one aspect, the configuration module 136 may be provided to change the configuration of the power packs 108, such as from series to parallel or vice versa. The configuration module 136 is described in FIG. 10.

FIG. 2 illustrates the charging database 116 according to a version of the present disclosure. In one aspect, the charging database 116 may be configured to store information related to various power packs used while charging and discharging from the modular multi-type power pack energy storage unit 100. In one aspect, the charging database 116 stores information of different varieties of power packs such as but not limited to supercapacitor units, lead-acid cells or batteries, lithium batteries, or other types of chemical and nonchemical power packs, including all those mentioned herein. Further, the charging database 116 may be configured to store information related to the power cycle of each of the plurality of power packs 108, the maximum and minimum charge for different types of power packs, and the state of charge (SoC) profile of each of the plurality of power packs 108. For example, a supercapacitor unit coupled to a golf cart has a charge cycle of 1 hour with a charging capacity of 60 percent, storing 13 Ah of the electric charge, and the supercapacitor unit, when charged to 60 percent of its capacity, delivers the electric charge for 15 minutes.

In one aspect, the charging database 116 may be configured to store the charging capacity of each of the plurality of power packs 108 when connected in series or parallel. In another aspect, the charging database 116 may also store the charging duration of each of the plurality of power packs 108 when connected in series or parallel. In one example, if ten supercapacitor units are connected in series, and each supercapacitor unit receives 13 Ah of the electric charge to reach 60 percent of their capacity for 20 minutes, then each of the ten supercapacitor units may deliver a charge cycle of one hour. Similarly, in another example, ten supercapacitor units are connected in parallel and each supercapacitor unit receives 10 Ah of the electric charge to reach 60 percent of their capacity for 30 minutes, and each supercapacitor unit can deliver the same charge cycle of 1 hour. In another example, ten supercapacitor units are connected in series or parallel, and each supercapacitor unit receives 17 Ah to reach 70 percent of its capacity for 24 minutes in series connection and 14 Ah to reach 70 percent of its capacity for 32 minutes in parallel connection, to deliver the charge cycle of 1.2 hours. Similarly, in the case of the ten supercapacitor units connected in series or parallel and charged 80 percent of their capacity, each supercapacitor unit receives 19 Ah of the electric charge within 29 minutes in series connection, and each supercapacitor unit receives 16 Ah of the electric charge within 34 minutes in parallel connection, and each supercapacitor unit delivers 1.6 hours of the charge cycle.

Further, the charging database 116 may be configured to store different types of power packs, such as supercapacitor units, lead-acid batteries, lithium batteries, etc. In one aspect, the charging database 116 may also store the bidirectional nature of charging or discharging of each of the plurality of power packs 108. In one example, if a supercapacitor unit is charged more than 90 percent of its capacity, the electric charge flowing into the supercapacitor unit reverses its direction to flow back. In another example, if a lithium battery is charged more than 80 percent of its capacity, the electric charge flowing into the lithium battery reverses its direction to flow back. In another example, if a lead-acid battery is charged more than 90 percent of its capacity, the electric charge flowing into the lead-acid battery reverses its direction to flow back.

FIGS. 3A-3B illustrates a flowchart showing a method 300 performed by the ECS 101, according to a version. FIGS. 3A-3B are described in conjunction with FIG. 1, FIG. 2, FIG. 4, FIG. 5, FIG. 6, FIG. 7, FIG. 8, FIG. 9, and FIG. 10. In one aspect, the ECS 101 may be configured to initiate each plurality of modules to enhance the performance and the capability of the plurality of power packs 108. It should also be noted that in some alternative implementations, the functions noted in the blocks may occur out of the order noted in the drawings. For example, two blocks shown in succession in FIG. 3A and FIG. 3B may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the ECS 101 may be configured to retrieve information related to the plurality of power packs 108 from the charging database 116 and the charging database 116, at step 302. In one aspect, the information related to each of the plurality of power packs 108 may be the type of power packs connected to the modular multi-type power pack energy storage unit 100, duty cycle or charge cycle of each power pack, the capacity of each power pack to store the electric charge. For example, the ECS 101 retrieves information from the charging database 116 that the power pack connected for charging is a lead-acid battery coupled to a golf cart, and the charging database 116 states that the charge cycle of the lead-acid battery is 08 for 4 hours, and the lead-acid battery, when charged to its maximum capacity, delivers the electric charge for 30 minutes. Further, the ECS 101 may trigger the electrostatic module at step 304.

Further, the electrostatic module (not shown) is described in FIG. 4. FIG. 4 illustrates a flowchart of a method 400 performed by the electrostatic module. It should also be noted that in some alternative implementations, the functions noted in the blocks may occur out of the order noted in the drawings. For example, two blocks shown in succession in FIG. 4 may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the electrostatic module (not shown) may receive a prompt from the ECS 101 at step 402. In one aspect, the electrostatic module may be configured to identify the power pack type and the capacity of each power pack connected to the modular multi-type power pack energy storage unit 100. Further, the electrostatic module may be configured to retrieve information related to the type of power packs from the charging database 116, at step 404. For example, the electrostatic module retrieves information from the charging database 116 that the plurality of power packs 108 connected to the modular multi-type power pack energy storage unit 100 are ten supercapacitor units, and these ten supercapacitor units are connected in series. Successively, the electrostatic module may determine the capacity of each power pack to be charged at step 406. In one aspect, the electrostatic module may be configured to determine the capacity of each power pack when connected to the modular multi-type power pack energy storage unit 100. For example, the electrostatic module determines that each of the ten supercapacitor units connected in series can store 20 Ah of the electric charge.

Further, the electrostatic module may be configured to determine if each power pack charged below the threshold limit at step 408. For example, in one aspect, the electrostatic module may check whether each of the plurality of power packs 108 may have the capacity below the threshold limit. In one case, the electrostatic module determines when the supercapacitor units are not charged below the threshold limit; then, the electrostatic module may proceed further to step 410, to send data related to the supercapacitor units to the ECS 101. For example, the electrostatic module determines that when the ten supercapacitor units are charged up to the threshold limit of 90 percent of the electric charge, they do not need to be charged. In another case, the electrostatic module determines that when the supercapacitor units are charged below the threshold limit, the electrostatic module may proceed further to step 412 to measure the percentage of supercapacitor units to be charged. For example, the electrostatic module determines that the five supercapacitor units charged up to 60 percent of the capacity need to be charged. Further, the electrostatic module may be configured to measure the percentage of power packs to be charged at step 412. For example, the electrostatic module measures that out of 10 supercapacitor units, five supercapacitor units are charged below 60 percent and need to be charged up to the threshold limit of 90 percent. Successively, the electrostatic module may be configured to send data related to power packs to the ECS 101, at step 414. For example, the electrostatic module sends to the ECS 101 that out of ten supercapacitor units, five supercapacitor units are charged below 60 percent and need to be charged up to the threshold limit of 90 percent.

Further, the ECS 101 may be configured to receive the data related to the power packs from the electrostatic module or other modules such as the performance module at step 306. For example, the ECS 101 receives the data that five supercapacitor units are charged below 60 percent and need to be charged up to the threshold limit of 90 percent and five supercapacitor units are charged up to the threshold limit of 90 percent of their capacity and therefore does not need charging. Successively, the ECS 101 may be configured to trigger the supercapacitor module 122 at step 308. Further, the supercapacitor module 122 is described in FIG. 5. FIG. 5 illustrates a flowchart of a method 500 performed by the supercapacitor module 122. It should also be noted that here and in the other drawings, in some alternative implementations, the functions noted in the blocks may occur out of the order noted in the drawings. For example, two blocks shown in succession in FIG. 5 may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the supercapacitor module 122 may be configured to receive a prompt from the ECS 101, at step 502. The supercapacitor module 122 may be configured to charge each plurality of power packs 108 up to the threshold limit. In one aspect, the plurality of power packs 108 may be supercapacitor units, and the threshold limit of each supercapacitor unit may be 90 percent of its capacity. In one aspect, the supercapacitor module 122 may be activated and deactivated automatically by the ECS 101 upon receiving a request from the electrostatic module related to the charging requirement of the plurality of power packs 108. Further, the supercapacitor module 122 may be configured to retrieve the charging requirement of the plurality of power packs 108 from the charging database 116, at step 504. In one aspect, the supercapacitor module 122 may be configured to retrieve the charging requirement of the plurality of power packs 108 to be used or consumed by the electric vehicle, such as golf cart, baby cart, electric car, etc., from the charging database 116. For example, the supercapacitor module 122 retrieves the charging requirement that ten supercapacitor units connected in series need to be charged up to the threshold limit of 90 percent of their capacity.

Further, the supercapacitor module 122 may be configured to measure the amount of electric charge of each of the plurality of power packs 108 via the communication configuration module 136 in real-time, at step 506. In one aspect, the supercapacitor module 122 may also determine the amount of charge left within each of the plurality of power packs 108 when connected with the modular multi-type power pack energy storage unit 100. In one aspect, the supercapacitor module 122, using the communication configuration module 136, measures the charge left on each of the plurality of power packs 108. For example, the supercapacitor module 122 measures the amount of the electric charge of the ten supercapacitor units when connected to the modular multi-type power pack energy storage unit; for instance, three supercapacitor units are fully drained, four supercapacitor units are still charged up to 60 percent, and three supercapacitor units are charged more than 90 percent of their capacity. Successively, the supercapacitor module 122 may determine if charging each of the plurality of power packs 108 is required at step 508. For example, the supercapacitor module 122 determines that three supercapacitor units need to be recharged from 0 percent of their capacity, and four supercapacitor units need to be recharged from 60 percent of their capacity. The rest of the three supercapacitor units are charged above the threshold limit of 90 percent.

In one case, the supercapacitor module 122 may determine that charging of each of the plurality of power packs 108 is not required, then the supercapacitor module 122 is redirected back to step 506 to measure the amount of electric charge of each power pack. For example, the supercapacitor module 122 determines if each of the ten supercapacitor units is charged up to the threshold limit of 90 percent of their capacity. In another case, the supercapacitor module 122 may determine that charging the plurality of power packs 108 is required; then, the supercapacitor module 122 may move to step 510. For example, the supercapacitor module 122 determines that if each of the ten supercapacitor units is completely drained to 0 percent of their capacity, then the supercapacitor module 122 proceeds to charge each power pack up to the threshold limit, at step 510. In one aspect, the threshold limit of the power packs may vary according to the desired usage of the power packs. For example, in one exemplary aspect, the threshold limit of each of 10 supercapacitor units may be up to 90 percent of their capacity to hold the electric charge of 25 Ah or 20 Ah for series or parallel connection. For example, the supercapacitor module 122 charges the three supercapacitor units initially at 0 percent of their capacity to 90 percent of their capacity.

Successively, the supercapacitor module 122 may be configured to send a first charging notification to the ECS 101 at step 512. For example, the supercapacitor module 122 sends the first charging notification that out of 10 supercapacitor units, three have been charged to the threshold limit of 90 percent. Four supercapacitor units are charged to 90 percent from 60 percent, and the rest of the three supercapacitor units are not charged. Further, the ECS 101 may be configured to receive the first charging notification from the supercapacitor module 122 at step 310. For example, the ECS 101 receives the first charging notification that out of 10 supercapacitor units, three have been charged to the threshold limit of 90 percent from initially with 0 percent of the electric charge, four supercapacitor units are charged to 90 percent from 60 percent, and the rest of 3 supercapacitor units are not charged.

Successively, the ECS 101 may be configured to trigger the lithium module 124 at step 312. For example, in one aspect, the lithium module 124 may determine whether there may be lithium batteries to charge or discharge. Further, the lithium module 124 is described in FIG. 6. FIG. 6 illustrates a flowchart of a method 600 performed by the lithium module 124. It should also be noted that the blocks in flow charts here or elsewhere in the drawings may generally be understood as representing decisions made by a hardware structure such as a state machine.

At first, the lithium module 124 may be configured to receive a prompt from the ECS 101 at step 602. The lithium module 124 may be configured to charge the plurality of power packs 108 up to the threshold limit. In one aspect, the plurality of power packs 108 may be lithium batteries, and each lithium battery's threshold limit may be 90 percent of its capacity. In one aspect, the lithium module 124 may be activated and deactivated automatically by the ECS 101 upon receiving the request from the electrostatic module related to the charging requirement of the plurality of power packs 108. Further, the lithium module 124 may be configured to retrieve the charging requirement of the plurality of power packs 108 from the charging database 116, at step 604. In one aspect, the lithium module 124 may be configured to retrieve the charging requirement of the plurality of power packs 108 to be used or consumed by the electric vehicle, such as golf cart, baby cart, electric car, etc., from the charging database 116. For example, the lithium module 124 retrieves the charging requirements that 15 lithium batteries connected in series need to be charged equal to more than 90 percent of their capacity.

Further, the lithium module 124 may be configured to measure the amount of electric charge of each of the plurality of power packs 108 via the communication configuration module 136 in real-time, at step 606. In one aspect, the lithium module 124 may also measure the charge left within each of the plurality of power packs 108 when connected with the modular multi-type power pack energy storage unit 100. In one aspect, the lithium module 124, using the communication configuration module 136, measures the amount of charge left on each of the plurality of power packs 108. For example, the lithium module 124, using the communication configuration module 136, determines that the 15 lithium batteries, when connected to the modular multi-type power pack energy storage unit, for instance, five lithium batteries are fully drained, four lithium batteries are still charged up to 60 percent, and six lithium batteries are charged more than 90 percent of their capacity. Successively, the lithium module 124 may determine if charging each of the plurality of power packs 108 is required at step 608. For example, the lithium module 124 determines that five lithium batteries need to be recharged from 30 percent of their capacity, four lithium batteries need to be recharged from 60 percent of their capacity, and the remaining six lithium batteries are charged above the threshold limit of 90 percent.

In one case, the lithium module 124 may determine that charging of each of the plurality of power packs 108 is not required, then the lithium module 124 is redirected back to step 606 to measure the amount of electric charge of each power pack. For example, lithium module 124 determines if each of the 15 lithium batteries is charged equal to or more than 90 percent of their capacity. In another case, the lithium module 124 may determine that charging the plurality of power packs 108 is required; then, the lithium module 124 may move to step 610. For example, the lithium module 124 determines that if each of the 15 lithium batteries is completely drained to 0 percent of their capacity, then the lithium module 124 may proceed to charge each power pack up to the threshold limit at step 610. In one aspect, the threshold limit of the power packs may vary according to the desired usage of the power packs. In one exemplary aspect, the threshold limit of each of 15 lithium batteries may be up to 90 percent of their capacity to hold the electric charge. For example, the lithium module 124 charges the five lithium batteries, which are at 0 percent of their capacity to 90 percent of their capacity for the electric vehicle to complete one run time along a road of one kilometer.

Successively, the lithium module 124 may be configured to send a second charging notification to the ECS 101 at step 612. For example, the lithium module 124 is configured to send the second charging notification that out of 15 lithium batteries, five have been charged to the threshold limit of 90 percent, four lithium batteries are charged to 90 percent from 60 percent, and the rest of 6 lithium batteries are not charged. Further, the ECS 101 may be configured to receive the second charging notification from the lithium module 124 at step 314. For example, the ECS 101 receives the second charging notification that out of 15 lithium batteries, five have been charged to the threshold limit of 90 percent from initially with 0 percent of the electric charge, four lithium batteries are charged to 90 percent from 60 percent, and the rest of 6 lithium batteries are not charged.

Successively, the ECS 101 may be configured to trigger the lead-acid module 126 at step 316. In one aspect, the lead-acid module 126 may determine whether there may be lead-acid batteries to charge or discharge. Further, the lead-acid module 126 is described in FIG. 7. FIG. 7 illustrates a flowchart of a method 700 performed by the lead-acid module 126. It should also be noted that in some alternative implementations, the functions noted in the blocks may occur out of the order noted in the drawings. For example, two blocks shown in succession in FIG. 7 may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the lead-acid module 126 may be configured to receive a prompt from the ECS 101, at step 702. The lead-acid module 126 may be configured to charge the plurality of power packs 108 up to the threshold limit. In one aspect, the plurality of power packs 108 may be lead-acid batteries, and the threshold limit of each lead-acid battery may be 90 percent of its capacity. In one aspect, the lead-acid module 126 may be activated and deactivated automatically by the ECS 101 upon receiving the request from the electrostatic module related to the charging requirement of the plurality of power packs 108. Further, the lead-acid module 126 may be configured to retrieve the charging requirement of the plurality of power packs 108 from the charging database 116, at step 704. In one aspect, the lead-acid module 126 may be configured to retrieve the charging requirement of the plurality of power packs 108 to be used or consumed by the electric vehicle, such as golf cart, baby cart, electric car, etc., from the charging database 116. For example, the lead-acid module 126 retrieves the charging requirements that ten lead-acid batteries connected in series need to be charged equal to more than 90 percent of their capacity.

Further, the lead-acid module 126 may be configured to measure the electric charge of each of the plurality of power packs 108 via the communication configuration module 136 in real-time, at step 706. In one aspect, the lead-acid module 126 may also measure the charge left within each of the plurality of power packs 108 when connected with the modular multi-type power pack energy storage unit 100. In another aspect, the lead-acid module 126, using the communication configuration module 136, measures the amount of charge left on each of the plurality of power packs 108. For example, the lead-acid module 126 measures that the ten lead-acid batteries when connected to the modular multi-type power pack energy storage unit, for instance, four lead batteries are fully drained, four lead-acid batteries are still charged up to 60 percent, and two lead-acid batteries are charged more than 90 percent of their capacity. Successively, the lead-acid module 126 may determine if charging each of the plurality of power pack 108 is required at step 708. For example, the lead-acid module 126 determines that four lead-acid batteries need to be recharged from 0 percent of their capacity, four lead-acid batteries need to be recharged from 60 percent of their capacity, and the remaining two lead-acid batteries are charged above the threshold limit of 90 percent.

In one case, the lead-acid module 126 may determine that charging of each of the plurality of power packs 108 is not required, then the lead-acid module 126 is redirected back to step 706 to measure the amount of electric charge of each power pack. For example, the lead-acid module 126 determines if each of the ten lead-acid batteries is charged equal to or more than 90 percent of their capacity. In another case, the lead-acid module 126 may determine that charging the plurality of power packs 108 is required; then, the lead-acid module 126 may move to step 710. For example, the lead-acid module 126 determines that if each of the ten lead-acid batteries is completely drained to 0 percent of their capacity, then the lead-acid module 126 may charge each power pack up to the threshold limit at step 710. In one aspect, the threshold limit of the power packs may vary according to the desired usage of the power packs. In one exemplary aspect, the threshold limit of each of 10 lead-acid batteries is up to 90 percent of their capacity to hold the electric charge. For example, the lead-acid module 126 charges the four lead-acid batteries, which are at 30 percent of their capacity to 90 percent of their capacity for the electric vehicle to complete one run time along a road of one kilometer.

Successively, the lead-acid module 126 may be configured to send a third charging notification to the ECS 101 at step 712. For example, the lead-acid module 126 is configured to send the third charging notification that out of 10 lead-acid batteries, four have been charged to the threshold limit of 90 percent, four lead-acid batteries are charged to 90 percent from 60 percent, and the rest of 2 lead-acid batteries are not charged. Further, the ECS 101 may be configured to receive the third charging notification from the lead-acid module 126 at step 318. For example, the ECS 101 receives the third charging notification that out of 10 lead-acid batteries, four have been charged to the threshold limit of 90 percent from initially with 0 percent of the electric charge, four lead-acid batteries are charged to 90 percent from 60 percent, and the rest of 2 lead-acid batteries are not charged.

Further, the ECS 101 may be configured to trigger identifier module 138 at step 320. In one aspect, the identifier module 138 may be configured to identify problems while charging the plurality of power packs 108. The identifier module 138 is described in conjunction with FIG. 8. FIG. 8 illustrates a flowchart of a method 800 performed by the identifier module 138.

At first, the identifier module 138 may be configured to receive a prompt from the ECS 101, at step 802. The identifier module 138 may be configured to determine the charge level required from each of the plurality of power packs 108. Further, the identifier module 138 may be configured to retrieve information related to the plurality of power packs 108 from the charging database 116, at step 804. In one aspect, the identifier module 138 may be configured to retrieve information related to the charging or discharging the plurality of power packs 108. For example, the identifier module 138 retrieves information that the ten lead-acid batteries connected to the modular multi-type power pack energy storage unit 100 have the state of charge profile as, ten lead-acid batteries have a charge cycle of 2 hours when charged more than 95 percent of their capacity, and the ten lead-acid batteries are charged up to 90 percent from the lead-acid module 126. Further, the identifier module 138 may be configured to examine the plurality of power packs during charging from the supercapacitor module 122, the lithium module 124, the lead-acid module 126, or the other module 128 at step 806. For example, the identifier module 138 performs examination that out of the ten lead-acid batteries, only six lead-acid batteries are charged up to 90 percent of their capacity, and the remaining four lead-acid batteries are not charged above 60 percent of their capacity due to the presence of more acid in the four lead-acid batteries.

Successively, the identifier module 138 may determine if the plurality of power packs 108 are properly charged above the threshold limit at step 808. In one aspect, the identifier module 138 may be configured to determine whether each of the plurality of power packs 108 may be charged above the threshold limit. In one case, the identifier module 138 may determine if the plurality of power packs 108 are charged below the threshold limit, then the identifier module 138 may proceed to step 810 to measure the amount of the electric charge required from each of the plurality of power packs 108. For example, the identifier module 138 determines that if the required electric charge from the ten lead-acid batteries is 20 hours of the charge cycle and out of the ten lead-acid batteries, six are charged above the threshold limit of 90 percent to deliver the charge cycle of 2 hours for each lead-acid battery and the remaining four which are charge below 60 percent of their capacity deliver the charge cycle for 1 hour only for each of these four lead-acid batteries. Therefore, identifier module 138 measures that the ten lead-acid batteries with the current state of charge profile can deliver only 16 hours of the charge cycle, and the identifier module 138 may then proceed to step 812, to send the information related to the charging requirements to the ECS 101.

In another case, the identifier module 138 may determine that if each of the plurality of power packs 108 are charged above the threshold limit, then the identifier module 138 may proceed to step 812 to send information related to the charging of the plurality of power packs 108 to the ECS 101. For example, the identifier module 138 determines that out of 10 lead-acid batteries, each of the ten lead-acid batteries are charged above the threshold limit of 90 percent to maintain the state of charge profile by delivering the continuous charge cycle for 20 hours from the ten lead-acid batteries. Further, the identifier module 138 may be configured to send the information related to the charging requirements of the plurality of power packs 108 to the ECS 101, at step 812. For example, the identifier module 138 is configured to send to the ECS 101 that out of 10 lead-acid batteries, four batteries need to be charged to achieve an overall charge cycle of 20 hours from the lead-acid batteries. Successively, the ECS 101 may be configured to receive information about charging the plurality of power packs 108 at step 322. For example, the ECS 101 receives that out of 10 lead-acid batteries, four batteries need to be charged to achieve an overall charge cycle of 20 hours from the lead-acid batteries.

Further, the ECS 101 may be configured to trigger the charging module 132 at step 324. Further, the charging module 132 is described in FIG. 9. FIG. 9 illustrates a flowchart of a method 900 performed by the charging module 132. It should also be noted that in some alternative implementations, the functions noted in the blocks may occur out of the order noted in the drawings. For example, two blocks shown in succession in FIG. 9 may be executed substantially concurrently, or the blocks may sometimes be executed in the reverse order, depending upon the functionality involved. In addition, the process descriptions or blocks in flow charts should be understood as representing decisions made by a hardware structure.

At first, the charging module 132 may be configured to receive a prompt from the ECS 101, at step 902. The charging module 132 may be configured to charge the plurality of power packs 108 to meet the desired charge cycle. In one aspect, the desired charge cycle of each of the plurality of power packs 108 may be 2 hours when each power pack is charged up to the threshold limit of 90 percent. In one aspect, the charging module 132 may be configured to activate or deactivated by the ECS 101 according to the information received from the identifier module 138 to charge or discharge the plurality of power packs 108, respectively. Successively, the charging module 132 may be configured to retrieve information related to the plurality of power packs 108 from the charging database 116, at step 904. In one aspect, the charging module 132 may retrieve information that each of the plurality of power packs 108 is charged below the threshold limit. For example, the charging module 132 retrieves information that the ten lead-acid batteries are charged nearly 80 percent of their capacity, which is below the threshold limit of 90 percent to deliver the desired charge cycle of 20 hours.

Further, the charging module 132 may be configured to measure the amount of electric charge stored in each of the plurality of power packs 108, at step 906. In one aspect, the charging module 132 may be configured to measure the charge stored in each of the plurality of power packs 108, which may be previously charged by their respective modules. For example, charging module 132 measures that out of the ten supercapacitor units, five are charged 70 percent of their capacity, four are charged 75 percent of their capacity, and one is charged above the threshold limit of 90 percent, by the supercapacitor module 122, and out of the 15 lithium batteries five are charged 90 percent of their capacity, six are charged around 60 percent of their capacity, and four are charged 70 percent of their capacity, by the lithium module 124, and similarly, out of the ten lead-acid batteries six are charged 90 percent of their capacity, and four are charged near 60 percent of their capacity, by the lead-acid module 126.

Further, the charging module 132 may determine if each of the plurality of power packs 108 is charged enough to deliver the desired charge cycle at step 908. In one aspect, the charging module 132 may determine whether each of the plurality of power packs 108 are charged enough for consumption or to be used during the specified or desired charge cycle. In one case, the charging module 132 may determine if the plurality of power packs 108 is not charged equal to or above the threshold limit to deliver the desired charge cycle from each power pack. For example, the charging module 132 determines that if the desired charge cycle from the ten lead-acid batteries is 20 hours and out of the ten lead-acid batteries, six are charged 90 percent of their capacity, and four are charged near 60 percent of their capacity, and the overall charge cycle of the ten lead-acid batteries is 16 hours, which is 4 hours less than the desired charge cycle. In this case, the charging module 132 may proceed to step 910 to charge the plurality of power packs 108 to meet the desired charge cycle. In another case, the charging module 132 may determine if the plurality of power packs 108 is equal to or above the threshold limit to deliver the desired charge cycle. For example, the charging module 132 determines that if the desired charge cycle from the ten lead-acid batteries is 20 hours, and each of the ten lead-acid batteries is charged above the threshold limit of 90 percent to deliver the charge cycle of 20 hours (2 hours from each lead-acid battery). In this case, the charging module 132 may proceed to step 912 to send the information related to the plurality of power packs 108.

Successively, the charging module 132 may be configured to charge the plurality of power packs 108 to meet the desired charge cycle at step 910. For example, the charging module 132 charges the ten lead-acid batteries if the desired charge cycle from the ten lead-acid batteries is 20 hours, and out of the ten lead-acid batteries, six are charged 90 percent of their capacity, and four are charged near 60 percent of their capacity, and the overall charge cycle of the ten lead-acid batteries is 16 hours, which is 4 hours less than the desired charge cycle, then the charging module 132 charges the rest of 4 lead-acid batteries up to the threshold limit of 90 percent to meet the desired charge cycle of 2 hours from each of the ten lead-acid batteries. Further, the charging module 132 may be configured to send the information about charging the plurality of power packs 108 to the ECS 101, at step 912. For example, the charging module 132 is configured to send to the ECS 101 that each of the ten lead-acid batteries is charged above the threshold limit of 90 percent to deliver the desired charging cycle of 20 hours. Successively, the ECS 101 receives the information related to charging required power packs from the charging module 132, at step 326. For example, the ECS 101 receives that each of the ten lead-acid batteries is charged above the threshold limit of 90 percent to deliver the desired charging cycle of 20 hours.

Further, the ECS 101 may be configured to send the information about charging the plurality of power packs 108 and the charge cycle to the display interface 110, at step 328. For example, the ECS 101 sends to the display interface 146 that each of the ten lead-acid batteries is charged above the threshold limit of 90 percent to deliver the desired charging cycle of 20 hours. Successively, the ECS 101 may be configured to trigger the dynamic module 134 at step 330. Further, the dynamic module 134 is described in FIG. 10. FIG. 10 illustrates a flowchart of a method 1000 performed by the dynamic module 134. It should also be noted that in some alternative implementations, the functions noted in the blocks may occur out of the order noted in the drawings. For example, two blocks shown in succession in FIG. 10 may be executed substantially concurrently, or the blocks may sometimes be executed in the reverse order, depending upon the functionality involved. In addition, the process descriptions or blocks in flow charts should be understood as representing decisions made by a hardware structure.

At first, the dynamic module 134 may be configured to receive a prompt from the ECS 101, at step 1002. The dynamic module 134 may be configured to restrict the flow of the electric charge in real-time towards each of the plurality of power packs 108 when each of the plurality of power packs 108 may be charged above the threshold limit. In one aspect, the flow of the electric charge may be restricted due to the bidirectional charging of each of the plurality of power packs 108 above the threshold limit. In one aspect, the dynamic module 134 may be configured to be activated or deactivated in real-time after the plurality of power packs 108 have been charged from the charging module 132. Further, the dynamic module 134 may be configured to retrieve information related to the charging or discharging the plurality of power packs 108 from the charging database 116, at step 1004. In one aspect, the dynamic module 134 may be configured to retrieve information related to the charging or discharging nature of each of the plurality of power packs 108. For example, the dynamic module 134 retrieves information that the ten lead-acid batteries when coupled in series and connected to the modular multi-type power energy storage unit 100 for charging up to the threshold limit of 90 percent, and after being charged up to 90 percent of their capacity, the electric charge flows in the reverse direction back into the modular multi-type power energy storage unit 100.

Successively, the dynamic module 134 may be configured to compare the charging and discharging of the plurality of power packs 108 in real-time with the retrieved charging and discharging of the plurality of power packs 108, at step 1006. In one aspect, the dynamic module 134 may be configured to compare in real-time the charging and discharging of each of the plurality of power packs 108 charged from the charging module 132 with the plurality of power packs 108 retrieved. For example, the dynamic module 134 compares that the ten lead-acid batteries when charged above the threshold limit of 90 percent of their capacity, the electric charge flows in the reverse direction back into the modular multi-type power energy storage unit 100, and the electric charge flowing into the ten lead-acid batteries when charged in real-time by the charging module 132, does not flow back until the each of the ten lead-acid batteries are charged up to 90 percent of their capacity, irrespective of the configuration of the batteries, such as in series or parallel.

Further, the dynamic module 134 may be configured to determine if the plurality of power packs 108 have bidirectional charging in real-time, at step 1008. In one aspect, the dynamic module 134 may be configured to determine if each of the plurality of power packs 108 being charged by the charging module 132 may have the bidirectional nature of the charge. In one case, the dynamic module 134 may determine that if the plurality of power packs 108 have bidirectional charging and discharging capability, the dynamic module 134 may proceed further to step 1010 to restrict the flow of the electric charge from the plurality of power packs above the threshold limit. For example, the dynamic module 134 determines that if each of the ten lead-acid batteries, when charged above the 90 percent of capacity, the electric charge flows back into the modular multi-type power pack energy storage unit 100, the dynamic module 134 is configured to restrict the flow of the electric chargeback by detaching the ten lead-acid batteries from the charging mode. It can be noted that the charging mode is an automatic preprogrammed actuation to start charging of the plurality of power packs 108. In this case, the dynamic module 134 is configured to send the real-time status of the plurality of power packs 108 to the ECS 101 at step 1012.

In another case, the dynamic module 134 may determine if the plurality of power packs 108 does not have bidirectional charging and discharging capability; the dynamic module 134 may proceed directly to step 1012 to send the real-time status of the plurality of power packs 108 to the ECS 101. For example, the dynamic module 134 determines that if each of the ten lead-acid batteries, when charged above the 90 percent of capacity, the electric charge does not flow back into the modular multi-type power pack energy storage unit 100, the dynamic module 134 is configured to send the real-time status of the ten lead-acid batteries to the ECS 101. Successively, the ECS 101 may be configured to receive the real-time status of the plurality of power packs 108 from the dynamic module 134, at step 332. For example, the ECS 101 receives that each of the ten lead-acid batteries, when charged above the 90 percent of capacity, the electric charge does not flow back into the modular multi-type power pack energy storage unit 100.

Successively, the ECS 101 may be configured to trigger the communication configuration module 136 at step 334. Further, the communication configuration module 136 is described in FIG. 11. FIG. 11 illustrates a flowchart of a method 1100 performed by the communication configuration module 136. It should also be noted that in some alternative implementations, the functions noted in the blocks may occur out of the order noted in the drawings. For example, two blocks shown in succession in FIG. 11 may be executed substantially concurrently, or the blocks may sometimes be executed in the reverse order, depending upon the functionality involved. In addition, the process descriptions or blocks in flow charts should be understood as representing decisions made by a hardware structure.

At first, the communication configuration module 136 may be configured to receive a prompt from the ECS 101, at step 1102. The communication configuration module 136 may be configured to change the configuration of the plurality of power packs 108 when connected to the modular multi-type power pack energy storage unit 100. In one aspect, the configuration may be series or parallel. In one aspect, the communication configuration module 136 may be configured to facilitate communication between the ECS 101 and the charging hardware 106. Further, the communication configuration module 136 may be configured to retrieve information related to the charging hardware 106 from the charging database 116, at step 1104. In one aspect, the communication configuration module 136 may be configured to retrieve the coupling of the plurality of power packs 108 within the charging hardware 106 from the charging database 116. In one example, the communication configuration module 136 retrieves that the ten lead-acid batteries are connected in series within the charging hardware 106 to receive the supply of the electric charge, and each of the ten lead-acid batteries is charged up to the threshold limit of 90 percent within 45 minutes of charging. In another example, the communication configuration module 136 retrieves that the ten lead-acid batteries are connected in parallel within the charging hardware 106 to receive the supply of the electric charge, and each of the ten lead-acid batteries is charged up to the threshold limit of 90 percent within 60 minutes of charging.

Successively, the communication configuration module 136 may be configured to measure the amount of charge being supplied to each of the plurality of power packs 108, at step 1106. In one aspect, the communication configuration module 136 may be configured to measure the electric charge supplied to the plurality of power packs from the charging module 134. For example, the communication configuration module 136 measures that out of the ten lead-acid batteries coupled in series, five lead-acid batteries are charged up to the threshold limit of 90 percent within 45 minutes of charging, rest of the five lead-acid batteries are charged below the threshold limit of 90 percent within these 35 minutes of charging. Further, the communication configuration module 136 may determine if the configuration of the plurality of power packs 108 is consuming more electric charge at step 1108. In one aspect, the communication configuration module 136 may be configured to determine that the plurality of power packs 108 consumes more electric charge than desired to charge each of the plurality of power packs 108 up to the threshold limit. In one case, the communication configuration module 136 may be configured to determine that the plurality of power packs 108 may consume more electric charge to reach the threshold limit. For example, the communication configuration module 136 determines that out of the ten lead-acid batteries coupled in series, each battery consumes a 25 Ah charge to reach the threshold limit of 90 percent of their capacity. In this case, the communication configuration module 136 may proceed to step 1110, to change the configuration of the plurality of power packs 108. In another case, the communication configuration module 136 may be configured to determine that the plurality of power packs 108 does not consume more electric charge to reach the threshold limit. For example, the communication configuration module 136 determines that each of the ten lead-acid batteries consumes 20 Ah of the electric charge to reach the desired threshold limit of 90 percent. In this case, the communication configuration module 136 may proceed to step 1112 to send the ECS 101 that no change in configuration is required.

Further, the communication configuration module 136 may be configured to change the configuration of the plurality of power packs 108 within the charging hardware 106, at step 1110. In one aspect, the plurality of power packs 108 may consume more electric charge to reach the threshold limit. For example, the communication configuration module 136 changes the configuration in a manner that out of the ten lead-acid batteries coupled in series, each battery consumes a 25 Ah charge to reach the threshold limit of 90 percent of their capacity. In this case, the ten lead-acid batteries are changed to parallel configuration. In this case, the communication and configuration module 136, after changing the configuration of the plurality of power packs 108, may be redirected back to step 1108, to determine whether the configuration of the plurality of power packs 108 is consuming more electric charge. Successively, the communication configuration module 136 may be configured to send any change in the configuration of the plurality of power packs 108 to the ECS 101, at step 1112. For example, the communication configuration module 136 is configured to send to the ECS 101 that the ten lead-acid batteries are consuming 25 Ah of electric charge when coupled in series to reach the threshold limit of 90 percent, and these ten lead-acid batteries when connected in parallel, consume only 20 Ah of the electric charge to reach the threshold limit of 90 percent. Therefore, the communication configuration module 136 may be configured to reduce the consumption of the electric charge while charging the plurality of power packs 108.

Successively, the ECS 101 may be configured to receive any change in configuration of the plurality of power packs 108, at step 336. For example, the ECS 101 receives that the ten lead-acid batteries are consuming 25 Ah of electric charge when coupled in series to reach the threshold limit of 90 percent, and these ten lead-acid batteries, when connected in parallel, consume only 20 Ah of the electric charge to reach the threshold limit of 90 percent. Further, the ECS 101 may be configured to send the change in configuration of the plurality of power packs 108 to the display interface 110, at step 338. For example, the display interface 146 display, the ten lead-acid batteries are consuming 25 Ah of electric charge when coupled in series to reach the threshold limit of 90 percent, and these ten lead-acid batteries, when connected in parallel, consume only 20 Ah of the electric charge to reach the threshold limit of 90 percent.

Aspects of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, aspects of the present disclosure may also be downloaded as one or more computer program products, wherein the program may be transferred from a remote computer to a requesting computer by way of data signals embodied in a carrier wave or other propagation medium via a communication link (e.g., a modem or network connection).

All patents and patent applications cited are to be understood as being incorporated by reference to the degree they are compatible herewith.

For all ranges given herein, it should be understood that any lower limit may be combined with any upper limit, when feasible. Thus, for example, citing a temperature range of from 5° C. to 150° C. and from 20° C. to 200° C. would also inherently include a range of from 5° C. to 200° C. and a range of 20° C. to 150° C.

When listing various aspects of the products, methods, or system described herein, it should be understood that any feature, element or limitation of one aspect, example, or claim may be combined with any other feature, element or limitation of any other aspect when feasible (i.e., not contradictory). Thus, disclosing an example of power pack comprising a temperature sensor and then a separate example of a power pack associated with an accelerometer would inherently disclose a power pack comprising or associated with an accelerometer and a temperature sensor.

Unless otherwise indicated, components such as software modules or other modules may be combined into a single module or component, or divided such that the function involves cooperation of two or more components or modules. Identifying an operation or feature as a discrete single entity should be understood to include division or combination such that the effect of the identified component is still achieved.

1. A system for energy management, comprising:
a plurality of power packs that include one or more supercapacitors and power control circuitry;
an energy control system comprising a processor coupled to a memory, the processor configured to control a flow of power associated with the plurality of power packs using the power control circuitry and based on data from a charging database; and
a display interface configured to display a status of the flow of power associated with the plurality of power packs.

2. The system of claim 1, wherein wherein the energy control system is part of a vehicle, wherein the energy control system is configured to anticipate power demand changes during operation of the vehicle and proactively adjust the flow of power associated with the plurality of power packs in response to the anticipated power demand changes.

3. The unit system of claim 1, wherein the power control circuitry includes a crosspoint switch that is configured to direct the flow of power associated with the plurality of power packs to use a first power pack of the plurality of power packs without using a second power pack of the plurality of power packs.

4. The system of claim 1, wherein the system has a distinctive electronic characteristic is determined by the power control circuitry wherein comparison of the distinctive electronic characteristic with a predetermined value is configured to verify that the system is authorized.

5. The system of claim 1, further comprising:
a photovoltaic array coupled to the plurality of power packs, wherein the photovoltaic array comprises a plurality of photovoltaic cells that are configured to supply electric charge to the plurality of power packs.

6. The system of claim 1, wherein the flow of power associated with the plurality packs is configured to charge the plurality of power packs.

7. The system of claim 1, wherein the flow of power associated with the plurality of power packs is configured to discharge the plurality of power packs to power one or more components of a vehicle.

8. The system of claim 1, wherein the one or more supercapacitors are coupled together in series.

9. The system of claim 1, wherein the one or more supercapacitors are coupled together in parallel.

10. The system of claim 1, wherein the plurality of power packs also include one or more electrochemical batteries in addition to the one or more supercapacitors, wherein the data from the charging database identifies one or more electrical characteristics of the one or more electrochemical batteries and one or more electrical characteristics of the one or more supercapacitors, and wherein the processor is configured to control the flow of power associated with the plurality of power packs using the power control circuitry and based on the one or more electrical characteristics of the one or more electrochemical batteries and the one or more electrical characteristics of the one or more supercapacitors.

11. The system of claim 10, wherein the one or more electrical characteristics of the one or more electrochemical batteries include a maximum discharge rate of the one or more electrochemical batteries, wherein the one or more electrical characteristics of the one or more supercapacitors include a maximum discharge rate of the one or more supercapacitors, wherein the flow of power associated with the plurality of power packs is a discharging of the plurality of power packs.

12. The system of claim 1, wherein the plurality of power packs include a plurality of power pack types including one or more electrochemical batteries and the one or more supercapacitors, wherein the data from the charging database identifies one or more electrical characteristics plurality of power pack types, and wherein the processor is configured to control a switch to connect the flow of power associated with the plurality of power packs to a first power pack type of the plurality of power pack types and disconnect the flow of power associated with the plurality of power packs from a second power pack type of the plurality of power pack types.

13. The system of claim 1, wherein the data from the charging database identifies charge statuses of the plurality of power packs, and wherein the processor is configured to control the flow of power associated with the plurality of power packs using the power control circuitry and based on the charge statuses of the plurality of power packs.

14. A method of energy management, the method comprising:
receiving data from a charging database;
controlling a flow of power associated with a plurality of power packs using power control circuitry and based on the data from the charging database, wherein the plurality of power packs include one or more supercapacitors and the power control circuitry; and
displaying a status of the flow of power associated with the plurality of power packs using a display interface.

15. The method of claim 14, further comprising:
anticipating power demand changes during operation of a vehicle; and
proactively adjusting the flow of power associated with the plurality of power packs in response to the anticipated power demand changes.

16. The method of claim 14, wherein the power control circuitry includes a crosspoint switch that is configured to direct the flow of power associated with the plurality of power packs to use a first power pack of the plurality of power packs without using a second power pack of the plurality of power packs.

17. The method of claim 14, wherein the plurality of power packs also include one or more electrochemical batteries in addition to the one or more supercapacitors, wherein the data from the charging database identifies one or more electrical characteristics of the one or more electrochemical batteries and one or more electrical characteristics of the one or more supercapacitors, and wherein controlling the flow of power associated with the plurality of power packs using power control circuitry and based on the data from the charging database includes controlling the flow of power associated with the plurality of power packs using the power control circuitry and based on the one or more electrical characteristics of the one or more electrochemical batteries and the one or more electrical characteristics of the one or more supercapacitors.

18. The method of claim 14, wherein the plurality of power packs include a plurality of power pack types including one or more electrochemical batteries and the one or more supercapacitors, wherein the data from the charging database identifies one or more electrical characteristics plurality of power pack types, and wherein controlling the flow of power associated with the plurality of power packs using power control circuitry and based on the data from the charging database includes controlling a switch to connect the flow of power associated with the plurality of power packs to a first power pack type of the plurality of power pack types and disconnect the flow of power associated with the plurality of power packs from a second power pack type of the plurality of power pack types.

19. The method of claim 14, wherein the data from the charging database identifies charge statuses of the plurality of power packs, and wherein controlling the flow of power associated with the plurality of power packs using power control circuitry and based on the data from the charging database includes controlling the flow of power associated with the plurality of power packs using the power control circuitry and based on the charge statuses of the plurality of power packs.

20. A non-transitory computer readable storage medium having embodied thereon a program, wherein the program is executable by a processor to perform a method of energy management the method comprising:
receiving data from a charging database;
controlling a flow of power associated with a plurality of power packs using power control circuitry and based on the data from the charging database, wherein the plurality of power packs include one or more supercapacitors and the power control circuitry; and
displaying a status of the flow of power associated with the plurality of power packs using a display interface.
